(19) United States
(12) Patent Application Publication
(10) Pub. No.: US 2026/0161352 A1
(43) Pub. Date: Jun. 11, 2026

(54) ELECTRONIC APPARATUS AND OPERATING METHOD THEREOF

(71) Applicant: Samsung Electronics Co., Ltd., Suwon-si (KR)

(72) Inventors: Donguk KIM, Suwon-si (KR); Sehyun KIM, Suwon-si (KR); Minhyo JUNG, Suwon-si (KR); Donghwa JEONG, Suwon-si (KR); Jongin LEE, Suwon-si (KR)

(21) Appl. No.: 19/423,557

(22) Filed: Dec. 17, 2025

Related U.S. Application Data
(63) Continuation of application No. PCT/KR2025/021120, filed on Dec. 9, 2025.

(30) Foreign Application Priority Data
Dec. 11, 2024 (KR) 10-2024-0184140

(51) Int. Cl. G06F 3/16

(52) U.S. Cl. CPC G06F 3/167

(57) ABSTRACT

An electronic apparatus for determining an artificial intelligence (AI) service provider apparatus includes at least one processor including processing circuitry and memory including at least one storage medium storing at least one instruction, wherein at least one processor individually or collectively is configured to execute the at least one instruction and to cause the electronic apparatus to obtain an utterance command of a user, determine at least one of the electronic apparatus or an external electronic apparatus as the AI service provider apparatus, based on the utterance command of the user and source information of contents displayed on a screen of at least one of the electronic apparatus or the external electronic apparatus, and control the electronic apparatus to perform an operation corresponding to the utterance command of the user through the determined AI service provider apparatus.

### CROSS-REFERENCE TO RELATED APPLICATIONS

This application is a continuation of International Application No. PCT/KR2025/021120 designating the United States, filed on Dec. 9, 2025, in the Korean Intellectual Property Receiving Office and claiming priority to Korean Patent Application No. 10-2024-0184140, filed on Dec. 11, 2024, in the Korean Intellectual Property Office, the disclosures of each of which are incorporated by reference herein in their entireties.

### BACKGROUND

### Field

The disclosure relates to an electronic apparatus and an operating method thereof. For example, the disclosure relates to an electronic apparatus for determining an artificial intelligence (AI) provider apparatus and an operating method of the electronic apparatus.

### Description of Related Art

Voice recognition technology is a technology of receiving a voice uttered by a user and providing an operation optimized for a user's question. In tandem with the development of artificial intelligence (AI) technologies, apparatuses that provide AI services by recognizing a voice (hereinafter, “AI service provider apparatus”) have been widely used. Such AI service provider apparatuses may receive and process a voice signal corresponding to an utterance of a user to provide various services to the user. For example, the AI service provider apparatuses may perform operations of recognizing and analyzing human languages (e.g., voice recognition, synthesis, understanding of natural language, generation, machine translation, dialogue system, etc.) to recognize a voice.

When the AI service provider apparatuses are installed in the same user space in a house, it may be unclear as to which apparatus is supposed to operate a command uttered by a user. In addition, as the AI service provider apparatuses have different device specifications or provide different services from each other, more efficient and effective processing of an utterance command is required.

### SUMMARY

An electronic apparatus according to an example embodiment of the disclosure includes at least one processor including processing circuitry and memory including at least one storage medium storing at least one instruction.

At least one processor according to an example embodiment of the disclosure may individually or collectively be configured to execute the at least one instruction and to cause the electronic apparatus to obtain an utterance command by a user.

At least one processor according to an example embodiment of the disclosure may individually or collectively be configured to execute the at least one instruction and to cause the electronic apparatus to determine at least one of the electronic apparatus or an external electronic apparatus as an artificial intelligence (AI) service provider apparatus, based on the utterance command by the user and source information of contents displayed on a screen of at least one of the electronic apparatus or the external electronic apparatus.

At least one processor according to an example embodiment of the disclosure may individually or collectively be configured to execute the at least one instruction and to cause the electronic apparatus to control the electronic apparatus to perform an operation corresponding to the utterance command by the user through the determined AI service provider apparatus.

A method of operating an electronic apparatus for determining an AI service provider apparatus according to an example embodiment of the disclosure includes: obtaining an utterance command by a user, determining at least one of the electronic apparatus or an external electronic apparatus as the AI service provider apparatus, based on the utterance command by the user and source information of contents displayed on a screen of at least one of the electronic apparatus or the external electronic apparatus, and controlling the electronic apparatus to perform an operation corresponding to the utterance command by the user through the determined AI service provider apparatus.

### BRIEF DESCRIPTION OF THE DRAWINGS

The above and other aspects, features and advantages of certain embodiments of the present disclosure will be more apparent from the following detailed description, taken in conjunction with the accompanying drawings, in which like reference numerals denote like elements, and in which:

FIG. 1 is a diagram illustrating an example artificial intelligence (AI) service provider system according to various embodiments;

FIG. 2 is a diagram illustrating information about a plurality of electronic apparatuses according to various embodiments;

FIG. 3 is a block diagram illustrating an example configuration of an electronic apparatus according to various embodiments;

FIG. 4 is a flowchart illustrating an example method of determining an AI service provider apparatus by an electronic apparatus according to various embodiments;

FIG. 5 is a diagram illustrating an example operation of providing by a first electronic apparatus an AI service according to an utterance command, based on the first electronic apparatus or a second electronic apparatus according to various embodiments;

FIG. 6 is a diagram illustrating an example operation of providing by a first electronic apparatus an AI service according to an utterance command, based on a server according to various embodiments;

FIG. 7 is a flowchart illustrating an example method of determining an AI service provider apparatus by an electronic apparatus based on contents source information according to various embodiments;

FIG. 8 is a flowchart illustrating an example method of providing an AI service by a first electronic apparatus and a second electronic apparatus based on contents source information according to various embodiments;

FIG. 9 is a diagram illustrating an example operation of providing an AI service by a first electronic apparatus based on contents source information of a second electronic apparatus according to various embodiments;

FIG. 10 is a diagram illustrating an example operation of providing an AI service by a first electronic apparatus based on contents source information of a second electronic apparatus according to various embodiments;

FIG. 11 is a flowchart illustrating an example method of determining a microphone activation apparatus and an AI service provider apparatus by an electronic apparatus according to various embodiments;

FIG. 12 is a diagram illustrating an example operation of determining a microphone activation apparatus and an AI service provider apparatus by a first electronic apparatus based on contents source information of a second electronic apparatus according to various embodiments;

FIG. 13 is a diagram illustrating an example operation of determining a microphone activation apparatus and an AI service provider apparatus by a first electronic apparatus based on contents source information of a second electronic apparatus according to various embodiments; and

FIG. 14 is a block diagram illustrating an example configuration of an electronic apparatus according to various embodiments.

### DETAILED DESCRIPTION

Throughout the disclosure, the expression “at least one of a, b or c” indicates only a, only b, only c, both a and b, both a and c, both b and c, all of a, b, and c, or variations thereof.

Hereinafter, various example embodiments of the disclosure are described in greater detail with reference to the accompanying drawings. However, the disclosure may be implemented in various different forms and is not limited to the example embodiments described herein.

General terms which are currently used widely have been selected for use in consideration of theirs functions in various embodiments; however, such terms may be changed according to an intention of a person skilled in the art, precedents, advent of new technologies, etc. Accordingly, the terms used in the disclosure should be defined based on their meanings and overall descriptions of the disclosure, not simply by their names.

The terms used in the disclosure are used merely to describe various embodiments and not intended to pose a limitation on the disclosure.

Throughout the disclosure, when a portion is described as being connected to another portion, the portion may be connected directly to another portion, or electrically connected to another portion with an intervening portion therebetween.

The use of the terms “a” and “an” and “the” and similar referents in the context of describing embodiments (especially in the context of the following claims) are to be construed to cover both the singular and the plural. Also, the steps of all methods described herein can be performed in any suitable order unless otherwise indicated herein or otherwise clearly contradicted by context. The disclosure is not limited to the described order of the steps.

The expressions “according to some embodiments,” “according to an embodiment of the disclosure,” etc. used throughout the disclosure are not intended to refer to the same embodiment.

Various embodiments may be described in terms of functional block components and various processing steps. Such functional blocks may be realized by any number of hardware and/or software components configured to perform the specified functions. For example, the functional blocks of the disclosure may be implemented by one or more microprocessors or by circuit components for certain functions. Furthermore, the functional blocks of the disclosure may be implemented with various programming or scripting languages. The functional blocks may be implemented in algorithms that are executed on one or more processors. Furthermore, embodiments could employ any number of conventional techniques for electronics configuration, signal processing and/or control, data processing and the like. The words “mechanism,” “element,” “means,” and “configuration” are used broadly and are not limited to mechanical or physical embodiments.

The connecting lines, or connectors shown in the various figures presented are intended to represent example functional relationships and/or physical or logical couplings between the various elements. It should be noted that many alternative or additional functional relationships, physical connections or logical connections may be present in a practical device.

Terms such as “unit” and “module” described in the disclosure may refer, for example, to a unit that processes at least one function or operation, and this may be implemented as hardware or software, or may be implemented as a combination of hardware and software.

In the disclosure, a “processor” may include various processing circuits and/or a plurality of processors. For example, the term “processor” as used in the detailed description and the claims, may include various types of processing circuitry by including at least one processor. One or more processors of the at least one processor may individually and/or collectively perform various functions described herein in a distributed manner. The “processor,” “at least one processor,” and “one or more processors” as used herein may be configured to perform various functions. However, such terms are used to cover the cases where one processor performs some of the functions while other processors perform other functions, or a single processor performs every functions. In addition, at least one processor may include a combination of processors performing various functions from among the functions described herein in a distributed manner. At least one processor may execute program instructions for achieving or performing various functions.

Throughout the disclosure, the term “user” may refer to a person using a display apparatus and may include a consumer, an evaluator, a viewer, a manger, or an engineer. Moreover, the terms “manufacturer” or “provider” used herein may refer to a manufacturer manufacturing a display apparatus and/or components included in a display apparatus.

Throughout the disclosure, the term “image” may include a still image, graphics, a picture, a frame, a motion clip including a plurality of consecutive still images, or a video.

Moreover, functions relating to “artificial intelligence (AI)” may be performed through a processor and memory. The processor may include at least one processor. In this regard, the at least one processor may be a generic-purpose processor such as CPU, AP, or DSP, a graphic processor such as a GPU or VPU, or a processor dedicated for artificial intelligence such as NPU. The at least one processor may control to process input data according to an artificial intelligence model or predefined operation rules stored in the memory. Or, when the at least one processor is a processor dedicated for artificial intelligence, it may be designed to have a hardware structure specialized to process a particular artificial intelligence model.

Throughout the disclosure, “predefined operation rules” or “AI model” are established through learning. In this regard, the establishment through learning may refer, for example, to a basic artificial intelligence model being trained using a number of learning data by a learning algorithm to establish predefined operation rules or an artificial intelligence model set to perform desired features (or objects). Such learning may be conducted by a device itself in which the artificial intelligence according to the disclosure is operated or through a separate server and/or a system. Examples of the learning algorithm include supervised learning, unsupervised learning, semi-supervised learning, and reinforcement learning; however, the disclosure is not limited thereto.

Throughout the disclosure, the “AI model” may be a model analyzing a linear or non-linear correlation among a plurality of operands (which may also be referred to as variables or parameters). For example, the AI model may include at least one of a linear regression model, a polynomial regression model, a logistic regression model, a decision trees model, a support vector machines (SVM) model, a linear correlation model, or a neural networks model; however, the disclosure is not limited thereto.

In an embodiment of the disclosure, the “AI model” may include a neural network model. The neural network model may include a plurality of neural network layers. The plurality of neural network layers may each have weight values and perform neural network calculations using calculation results of previous layer and calculations among a plurality of weight values. The plurality of weight values of the plurality of neural network layers may be optimized by learning results of the artificial intelligence model. For example, the plurality of weight values may be updated to reduce or minimize a loss value or a cost value obtained in the artificial intelligence model during a learning process. An AI neural network model may include a deep neural network (DNN), and may include, for example, and without limitation, a convolutional neural network (CNN), a recurrent neural network (RNN), a restricted boltzmann machine (RBM), a deep belief network (DBN), a bidirectional recurrent deep neural network (BRDNN), a deep Q-network, or the like; however, the disclosure is not limited thereto.

In this disclosure, the terms “AI service” may refer to a service facilitating the user of various AI functions based on an AI model. The AI service may be provided through on-device or cloud infrastructures and may provide services using various technologies such as machine learning (ML), natural language processing (NLP), natural language understanding (NLU), computer vision, etc.

Throughout the disclosure, the term “AI service provider apparatus” may refer to an apparatus for providing various AI services. The AI service provider apparatus may provide various AI services via on-device or cloud infrastructures.

Throughout the disclosure, the term “on-device AI service” may refer to an AI service that may be provided thorough an AI model executed in a device without internet connection. The on-device AI service may be a service that may be used offline and have a high response speed. For example, a lightweight AI model may be equipped in a device providing the on-device AI service, and the AI model may be executed through an AI-dedicated processor in a device. Throughout the disclosure, the “on-device AI service” may also be referred to as a device-based AI service.

The term “cloud AI service” may refer to an AI service that processes data through internet and provides the results to a user. The could AI service may be a high-performance AI service that processes complex operations or large-scale data in a cloud server without depending on the performance of a local device. For example, the device may request a necessary AI service by communicating with a cloud server, and the cloud server may execute an AI model corresponding to the AI service and then deliver the execution results to the device. The device may provide the execution results received from the cloud server. Throughout the disclosure, the “cloud AI service” may also be referred to as a server-based AI service.

In the disclosure, a “user command” may include a text input or a voice input including one or more words and/or one or more sentences. A user input may refer to an input for interaction with an AI model. The user input may be extracted as a natural language text through natural language processing (NLP). For example, a voice uttered by a user may be converted into a user utterance text through automatic speech recognition (ASR) and may be extracted as a natural language text through NLP. Throughout the disclosure, the term “user command” may be replaced with “user input,” “input,” “input phrase,” “directive,” “starting sentence,” “task query,” “trigger sentence,” “message,” “prompt,” etc. ; however, the disclosure is not limited thereto.

In the disclosure, contents may be received by a device from a contents provider such as a broadcasting signal, a streaming service, a Blu-ray player, a game console, etc. However, the disclosure is not limited thereto.

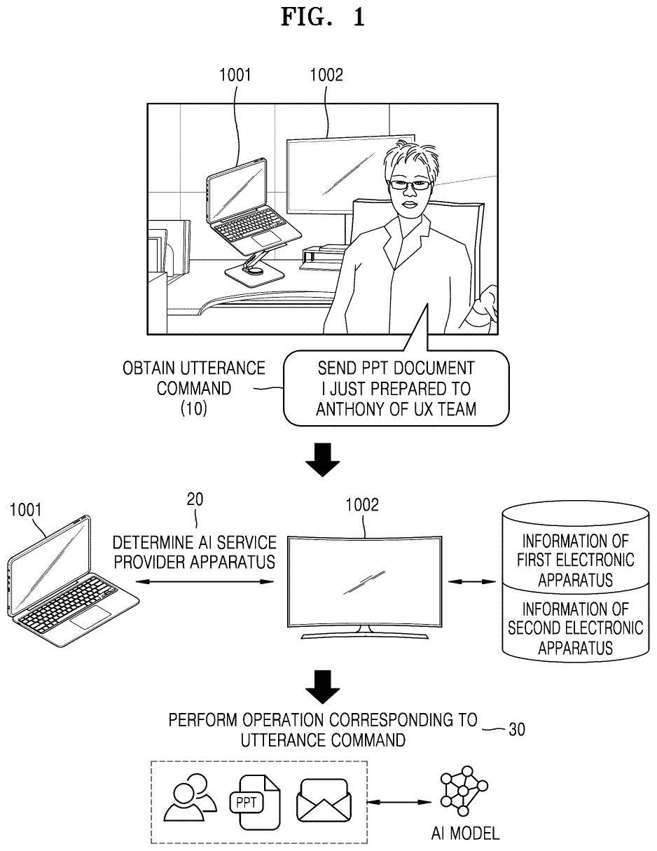

FIG. 1 is a diagram illustrating an example operation of providing an AI service in an AI service provider system according to various embodiments.

Referring to FIG. 1, the AI service provider system according to an embodiment of the disclosure may include a plurality of electronic apparatuses 1001 and 1002. Each of the plurality of electronic apparatuses 1001 and 1002 may be arranged in a house. Each of the plurality of electronic apparatuses 1001 and 1002 may be an apparatus performing an operation of recognizing and analyzing a human language, e.g., voice recognition, synthesis, natural language understanding, generation, machine translation, dialogue system, etc. by receiving and processing a voice uttered by a user. Each of the plurality of electronic apparatuses 1001 and 1002 may provide various AI services that may recognize a voice. Each of the plurality of electronic apparatuses 1001 and 1002 may be an apparatus providing at least one of a device-based AI service or a server-based AI service.

Each of the plurality of electronic apparatuses 1001 and 1002 according to an embodiment of the disclosure may be implemented as various forms such as, for example, and without limitation, a television (TV), a smart monitor, a mobile phone, a smartphone, a tablet personal computer (PC), a digital camera, a camcorder, a laptop computer, a desktop, an electronic book terminal, a digital broadcasting terminal, a personal digital assistant (PDA), a portable multimedia player (PMP), a navigation, an MP3 player, a digital video disk (DVD) player, a wearable device, a video wall, a digital signage, a digital information display (DID), a projector display, a refrigerator, a washing machine, etc. Each of the plurality of electronic apparatuses 1001 and 1002 may be a fixed electronic apparatus arranged in a fixed position or a portable electronic apparatus having a mobile form and may be a digital broadcasting receiver that may receive digital broadcasting. However, the disclosure is not limited thereto.

In the disclosure, although the first electronic apparatus 1001 is illustrated as a PC, and the second electronic apparatus 1002 is illustrated as a monitor, the disclosure is not limited thereto. For example, the first electronic apparatus 1001 may be a monitor, and the second electronic apparatus 1002 may be a PC. Or, for example, the first electronic apparatus 1001 and the second electronic apparatus 1002 may be an apparatus of the same type.

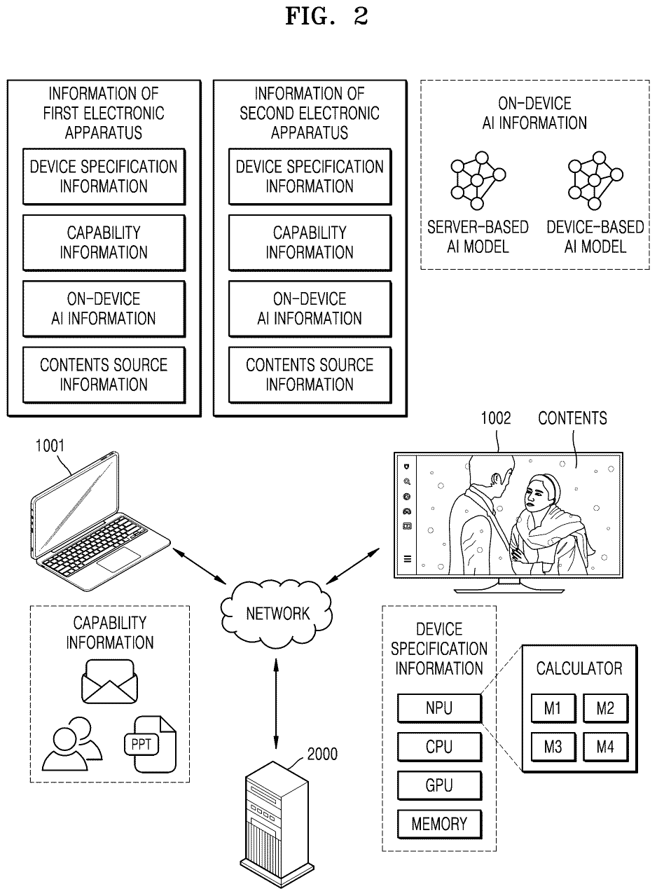

The plurality of electronic apparatuses 1001 and 1002 according to an embodiment of the disclosure may be connected to each other. For example, the plurality of electronic apparatuses 1001 and 1002 may be connected to each other via the same network. The plurality of electronic apparatuses 1001 and 1002 according to an embodiment of the disclosure may be connected to the same user account. The plurality of electronic apparatuses 1001 and 1002 connected to the same network and/or user account may share electronic apparatus information with each other. For example, the plurality of electronic apparatuses 1001 and 1002 may respectively pre-store information about the first electronic apparatus 1001 and information about the second electronic apparatus 1002. Description of the electronic apparatus information is further provided in greater detail below with reference to FIG. 2.

Each of the plurality of electronic apparatuses 1001 and 1002 according to an embodiment of the disclosure may include a microphone for receiving an utterance command by a user. In an environment where the plurality of electronic apparatuses 1001 and 1002 are present in a house, when a user make an utterance, at least one of the plurality of electronic apparatuses 1001 and 1002 may receive an utterance command by the user through a microphone. At least one of the plurality of electronic apparatuses 1001 and 1002 may determine by which apparatus the command uttered by the user is to be processed, based on the utterance command by the user and information about each of the plurality of electronic apparatuses 1001 and 1002. For example, at least one of the electronic apparatuses 1001 and 1002 may determine at least one of the plurality of electronic apparatuses 1001 and 1002 as an AI service provider apparatus using information such as device specification of each of the plurality of electronic apparatuses 1001 and 1002, available services, source information of currently-displayed contents, etc.

For example, in operation 10, at least one of the plurality of electronic apparatuses 1001 and 1002 may obtain an utterance command by the user. For example, at least one of the plurality of electronic apparatuses 1001 and 1002 may obtain an utterance command such as “send the PPT document I just prepared to Anthony of UX team.”

In operation 20, the at least one of the plurality of electronic apparatuses 1001 and 1002 which has obtained the utterance command by the user may determine an AI service provider apparatus corresponding to the utterance command by the user. The at least one apparatus may determine at least one of the plurality of electronic apparatuses 1001 and 1002 as an AI service provider apparatus based on each of the utterance command by the user, information about the first electronic apparatus 1001, and information about the second electronic apparatus 1002. For example, the at least one apparatus may determine the first electronic apparatus 1001 capable of executing a PPT program, an e-mail program, an address program, etc. (e.g., a PC) as an AI service provider apparatus. The at least one apparatus may determine an apparatus capable of performing natural language processing (NLP) as an AI service provider apparatus when the utterance command is a natural language text.

In operation 30, between the plurality of electronic apparatuses 1001 and 1002, an apparatus that has been determined as an AI service provider apparatus may perform an operation corresponding to the utterance command. For example, when the first electronic apparatus 1001 receives an utterance command by a user and determines itself as an AI service provider apparatus, the first electronic apparatus 1001 may grasp a context and an intent of the utterance command by the user through NLP and then perform an operation using a PPT program, an e-mail program, an address program, etc. Or, for example, when the first electronic apparatus 1001 receives an utterance command by the user and determines the second electronic apparatus 1002 as an AI service provider apparatus, the utterance command by the user may be transmitted to the second electronic apparatus 1002. In this case, the second electronic apparatus 1002 may analyze the utterance command by the user received from the first electronic apparatus 1001 and perform an operation corresponding to the utterance command by the user.

In an AI service environment including the plurality of electronic apparatuses 1001 and 1002, the plurality of electronic apparatuses 1001 and 1002 may determine an apparatus that may provide more efficient and effective AI services between the plurality of electronic apparatuses 1001 and 1002, based on the utterance command by the user and information about each of the plurality of electronic apparatuses 1001 and 1002. The determined electronic apparatus may provide AI service more efficiently and effectively by performing an operation corresponding to the utterance command by the user. The foregoing is described in greater detail below with reference to FIGS. 2 to 6.

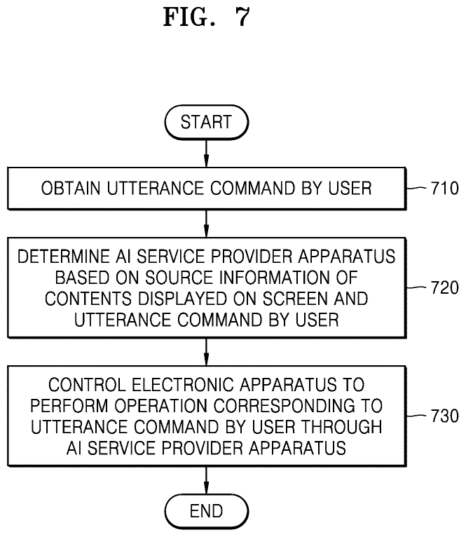

For example, at least one of the plurality of electronic apparatuses 1001 and 1002 may obtain an utterance command by a user and determine an AI service provider apparatus based on source information of contents displayed on at least one of the plurality of electronic apparatuses 1001 and 1002. The foregoing is described in greater detail below with reference to FIGS. 7 to 10.

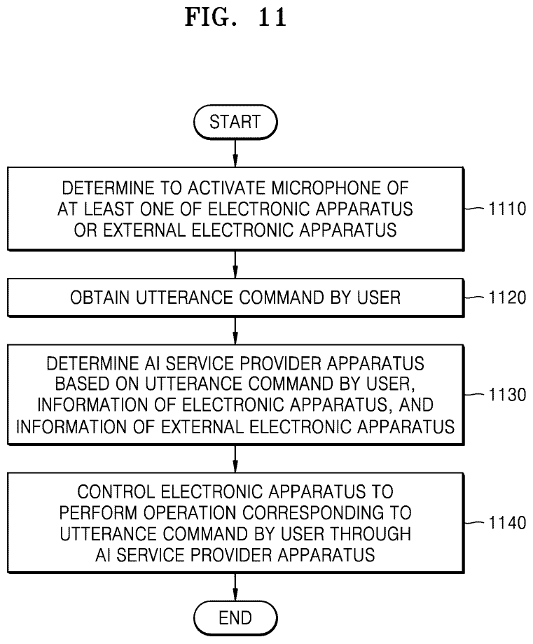

For example, when the plurality of electronic apparatuses 1001 and 1002 include a microphone, at least one of the plurality of electronic apparatuses 1001 and 1002 may determine an apparatus for activating a microphone and obtain an utterance command by the user through the activated microphone. The foregoing is described in greater detail below with reference to FIGS. 11 to 13.

FIG. 2 is a diagram illustrating example information about a plurality of electronic apparatuses according to various embodiments. FIG. 2 illustrates a system including the plurality of electronic apparatuses 1001 and 1002 providing AI services. When any one of the first electronic apparatus 1001 or the second electronic apparatus 1002 is referred to as an “electronic apparatus,” the other one of the first electronic apparatus 1001 or the second electronic apparatus 1002 may be referred to as an “external electronic apparatus.

Referring to FIG. 2, the plurality of electronic apparatuses 1001 and 1002 according to an embodiment of the disclosure may be connected to each other. For example, the plurality of electronic apparatuses 1001 and 1002 may be connected to each other via the same network. For example, the network may include at least one of a short range communication network, a long distance communication network, or a mobile communication network. For example, the plurality of electronic apparatuses 1001 and 1002 may be connected directly to each other via the short range communication network.

The plurality of electronic apparatuses 1001 and 1002 according to an embodiment of the disclosure may be connected to the same user account. For example, a server 2000 may mange user account information and information of the plurality of electronic apparatuses 1001 and 1002 connected to a user account. For example, a user may create a user account by connecting to the server 2000 through the plurality of electronic apparatuses 1001 and 1002. The user account may be identified by an ID and a password set by the user. The server 2000 may register the plurality of electronic apparatuses 1001 and 1002 to the user account according to predetermined steps. For example, the server 2000 may connect identification information of the plurality of electronic apparatuses 1001 and 1002 (e.g., serial number or MAC address) to the user account to register the plurality of electronic apparatuses 1001 and 1002. The plurality of electronic apparatuses 1001 and 1002 may be indirectly connected to each other via a network or the server 2000.

The plurality of electronic apparatuses 1001 and 1002 connected to the same network and/or user account may share electronic apparatus information with each other. The plurality of electronic apparatuses 1001 and 1002 may transmit their own information to the outside and store information received from the outside in memory. The plurality of electronic apparatuses 1001 and 1002 according to an embodiment of the disclosure may transmit, store, manage, or update their electronic apparatus information. For example, the first electronic apparatus 1001 may pre-store information about the first electronic apparatus 1001 and information about the second electronic apparatus 1002. The second electronic apparatus 1002 may pre-store information about the first electronic apparatus 1001 and information about the second electronic apparatus 1002. The plurality of electronic apparatuses 1001 and 1002 may periodically share information about them after being connected to each other for the first time; however, the disclosure is not limited thereto.

In an embodiment of the disclosure, information about each of the plurality of electronic apparatuses 1001 and 1002 may be used for determination of an AI service provider apparatus corresponding to the utterance command by the user. For example, each of the plurality of electronic apparatuses 1001 and 1002 may determine an AI service provider apparatus capable of processing the utterance command by the user more efficiently and effectively, based on the information of the first electronic apparatus 1001 and the information of the second electronic apparatus 1002. For example, between the plurality of electronic apparatuses 1001 and 1002, an apparatus which has obtained the utterance command by the user may determine whether to decide itself or an external electronic apparatus as an AI service provider apparatus, based on the utterance command by the user and information of each of the plurality of electronic apparatuses 1001 and 1002.

In an embodiment of the disclosure, information of each of the plurality of electronic apparatuses may be used in determining a method of providing an AI service corresponding to the utterance command by the user (for example, device-based or sever-based). For example, the plurality of electronic apparatuses 1001 and 1002 may determine a method of providing an AI service capable of processing the utterance command by the user more efficiently and effectively, based on the information of the first electronic apparatus 1001 and the information of the second electronic apparatus 1002. For example, between the plurality of electronic apparatuses 1001 and 1002, an apparatus which has received the utterance command by the user may determine the method of providing an AI service to be device-based or server-based, based on the utterance command by the user and information of each of the plurality of electronic apparatuses 1001 and 1002. For example, the AI service provider apparatus may provide at least one of a device-based AI service or a server-based AI service in correspondence with the utterance command by the user.

In an embodiment of the disclosure, information of the electronic apparatus may include information used in determining an AI service provider apparatus and/or a method of providing an AI service corresponding to the utterance command by the user. In an embodiment of the disclosure, the information of the electronic apparatus may include device specification information, capability information, on-device AI information, and contents source information.

In an embodiment of the disclosure, the device specification information may include detailed information relating to device hardware and performance. For example, the device specification information may include device type information (e.g., PC, monitor, etc.), information about at least one processor (e.g., NPU, CPU, GPU, etc.) included in the electronic apparatus (e.g., processor type information, processor capacity information, processor core information, processor performance information, etc.), and information about at least one memory (e.g., RAM) included in the electronic apparatus (e.g., memory type information, memory capacity information, memory performance information, etc.) For example, the processor performance information may include performance information of an AI-dedicated processor (e.g., NPU), and the performance information of the AI processor may be determined by resource information (e.g., the number of operators M1, M2, M3, and M4, capacity of memory, frequency bandwidth, etc.) The greater the amount of the resources is, the higher the performance of the processor may be. In addition, the device specification information may further include AI service type information, on-device AI service information, on-device AI model performance information, etc. For example, the AI service type information may include types of AI services that may be provided by a device (e.g., object recognition, natural language processing, etc.) For example, the on-device AI service information may include at least one of information about whether the device supports device-based AI services, information about whether the device supports server-based AI services, or occupancy information of AI-dedicated processor (e.g., NPU) (or information of remaining amount of resources). For example, the on-device AI model performance information may include parameter number information of an AI model. The greater the number of parameters of an AI model is, the longer the time required for computation may be.

In an embodiment of the disclosure, an AI service provider apparatus corresponding to the utterance command by the user may be determined based on the device specification information. For example, the electronic apparatus may identify device specification required to provide an AI service corresponding to the utterance command by the user and determine an apparatus supporting such device specification as an AI service provider apparatus. For example, when the utterance command by the user is a natural language text, an apparatus capable of performing the NLP may be determined as an AI service provider apparatus. In addition, when both apparatuses are capable of performing the NLP, an apparatus capable of performing device-based NLP (that is, on-device AI apparatus) may be determined as an AI service provider apparatus. When there are a plurality of on-device AI apparatuses, from among the plurality of apparatuses, an apparatus having better NPU performance, better AI model performance, or greater remaining amount of NPU resources may be determined as an AI service provider apparatus. For example, when there is no such apparatus including a required model, an apparatus providing server-based AI services may be determined as an AI service provider apparatus. However, the disclosure is not limited thereto.

In an embodiment of the disclosure, the capability information may include information about functions that may be processed in a device. For example, the capability information may include information about whether it is possible to carry out a specific task such as sending an e-mail, converting a file extension (e.g., PPT into DOC), executing a meeting program and participating in a meeting, telling the weather, showing stock market conditions, providing news, setting an alarm, executing an application in a device, etc.

In an embodiment of the disclosure, an AI service provider apparatus corresponding to the utterance command by the user may be determined based on the capability information. For example, the electronic apparatus may identify types of capability required to provide an AI service corresponding to the utterance command by the user and determine an apparatus supporting such capability as an AI service provider apparatus.

In an embodiment of the disclosure, the on-device AI-related information may include information for determining an AI service provider apparatus and/or information for determining a method of providing an AI service. For example, the on-device AI-related information may include at least one of information about device-based AI service support, information about server-based AI service support, AI-dedicated processor performance information, AI processor occupancy information, and/or on-device AI model performance information. The on-device AI-related information may include some elements overlapping with the elements included in the device specification information described above. In addition, the on-device AI-related information may include network environment information of an electronic apparatus. For example, when the network environment of an electronic apparatus is offline, as the server-based AI service cannot be provided, the electronic apparatus may determine the method of providing AI services to be device-based.

In an embodiment of the disclosure, the method of providing AI services (AI service provision method) may be determined based on at least one of the device specification information or the on-device AI-related information. For example, the electronic apparatus may determine whether the AI services are provided by an AI service provider apparatus in a device-based manner or in a server-based manner. For example, when the network environment is offline, the provision method may be determined to be device-based. When a user wishes high-speed operation processing, the provision method may be determined to be server-based. When the remaining amount of NPU resources is small, the provision amount may be determined to be server-based. For example, when an AI service provider apparatus subscribes to paid server-based AI services, the provision method may be determined to be server-based.

In an embodiment of the disclosure, the contents source information may include information about a source device (or source of supply) of contents displayed on a screen of an electronic apparatus. For example, the first electronic apparatus 1001 and the second electronic apparatus 1002 may be connected to each other via wireless connection such as mirroring, casting, etc. or wired connection using a cable (e.g., HDMI). In this case, any one of the plurality of electronic apparatuses 1001 and 1002 may be a source device transmitting contents, and the other one of the plurality of electronic apparatuses 1001 and 1002 may be a sink device receiving and outputting the contents.

For example, each of the first electronic apparatus 1001 and the second electronic apparatus 1002 may be a device including an operating system (OS) and an internet connection function. In this case, each of the first electronic apparatus 1001 and the second electronic apparatus 1002 may execute applications of various types using an OS included therein to output contents. In this case, the source of the contents displayed on the screen of the electronic apparatus may be the electronic apparatus itself.

In an embodiment of the disclosure, the first electronic apparatus 1001 and the second electronic apparatus 1002 may share contents source information with each other. For example, the electronic apparatus may store at least one of the contents source information of the electronic apparatus or the contents source information of the external electronic apparatus. For example, the external electronic apparatus may transmit source information of content every time a source of display contents changes. The electronic apparatus may store the source information of the contents received from the external electronic apparatus in memory.

In an embodiment of the disclosure, an AI service provider apparatus corresponding to the utterance command by the user may be determined based on the source information of the contents displayed on the screen of at least one of the plurality of electronic apparatuses 1001 and 1002. The electronic apparatus may determine an apparatus that is a source of the contents displayed on a screen of at least one of the electronic apparatus or the external electronic apparatus as an AI service provider apparatus. For example, when the source of the contents output by the electronic apparatus is the external electronic apparatus, as it is more effective for the external electronic apparatus to process the utterance command by the user, the external electronic apparatus may be determined to be an AI service provider apparatus. When the source of the contents output by the electronic apparatus is the electronic apparatus itself, as it is more effective for the electronic apparatus to process the utterance command by the user, the electronic apparatus may be determined to be an AI service provider apparatus.

Hereinafter, an example in which the first electronic apparatus 1001 is a PC, and the second electronic apparatus 1002 is a monitor is described. The monitor and the PC may be connected to each other. The monitor may receive and output contents from the PC through wireless connection or wired connection. In this case, the PC may be a source device, and the monitor may be a sink device. The monitor may be a smart monitor including an OS and an internet connection function. In this case, the monitor may not only receive and output contents from the PC but also execute applications using the OS. When the monitor receives and outputs the contents from the PC, the source of the contents on the screen of the monitor may be the PC. When the monitor outputs contents by executing the applications through the OS installed therein, the source of the contents on the screen of the monitor may be the monitor itself. The monitor and the PC may share the contents source information with each other. For example, the monitor may transmit the source information of the contents to the PC whenever the source of the displayed contents changes. The PC may store the source information of the contents received from the monitor in memory. When the PC obtains the utterance command by the user, and the source of the contents on the monitor is the PC, the PC may be determined to be an AI service provider apparatus corresponding to the utterance command by the user. When the source of the contents on the monitor is the monitor, the monitor may be determined to be an AI service provider apparatus corresponding to the utterance command by the user. However, the disclosure is not limited thereto, and the same goes for the case where the first electronic apparatus 1001 is the monitor, and the second electronic apparatus 1002 is the PC.

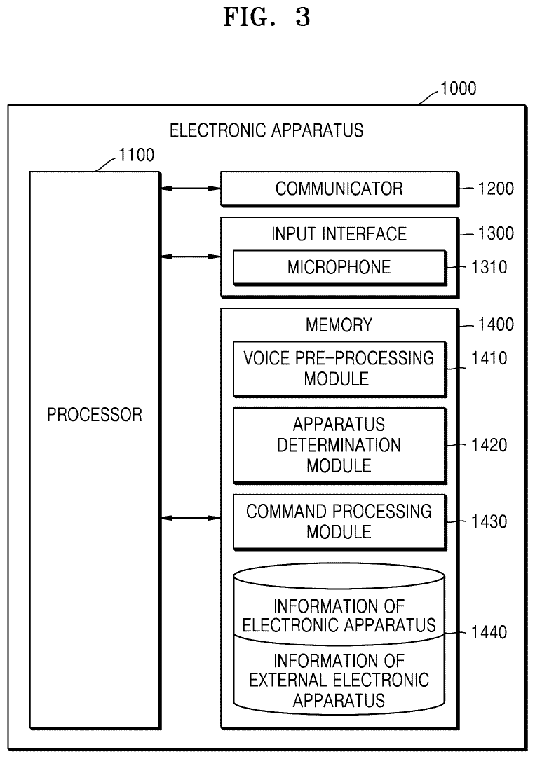

FIG. 3 is a block diagram illustrating an example configuration of an electronic apparatus according to various embodiments.

Referring to FIG. 3, an electronic apparatus 1000 according to an embodiment of the disclosure may be any one of the plurality of electronic apparatuses 1001 and 1002 of FIGS. 1 and 2. The external electronic apparatus may be the other one of the plurality of electronic apparatuses 1001 and 1002 of FIGS. 1 and 2.

The electronic apparatus 1000 according to an embodiment of the disclosure may include a processor (e.g., including processing circuitry) 1100, a communicator (e.g., including communication circuitry) 1200, an input interface (e.g., including input circuitry) 1300, and memory 1400. However, the components described herein are not necessarily essential. The electronic apparatus 1000 may be implemented by more or less components than the described components. In the disclosure, a “module” may be implemented by executing, by at least one processor included in the electronic apparatus 1000, a software such as a program code, an instruction, an algorithm, a data structure stored in the memory included in the electronic apparatus 1000. Hereinafter, the operations described to be performed by a module of the electronic apparatus 1000 may actually be performed by at least one processor included in the electronic apparatus 1000.

The communicator 1200 may include various communication circuitry and connect the electronic apparatus 1000 to a peripheral device, an external apparatus, a server, a mobile terminal, etc. by the control by the processor 1100. The communicator 1200 may include various communication circuits included in at least one communication module. The communicator 1200 may include a short-range communication module, a wireless internet module, a wired ethernet etc. in correspondence with the performance and structure of the electronic apparatus 1000.

The short-range communication module may be a module for short range communication and may include a WLAN module (Wi-F-module), a Bluetooth module, a Zigbee module, an infrared data association (IrDA) module, a Wi-Fi direct (WFD) module, etc. ; however, the disclosure is not limited thereto.

The wireless internet module may be a module for wireless internet connection and may be embedded in a device or installed outside a device. The wireless internet module may include a WLAN module, a wireless broadband (Wibro) module, etc. The wireless internet module may be sued communication between a source apparatus 100 and a server apparatus. When the WLAN module is for connection with the internet through an access point, the WLAN module may be used as a wireless internet module.

In an embodiment of the disclosure, the electronic apparatus 1000 may be connected to an external electronic apparatus through the communicator 1200. The electronic apparatus 1000 and the external electronic apparatus may be connected to the same network through the communicator 1200.

In an embodiment of the disclosure, the electronic apparatus 1000 may be connected to a server (for example, 2000 of FIG. 2) through the communicator 1200. The electronic apparatus 1000 may register a user account by accessing the server through the communicator 1200. The electronic apparatus 1000 may be indirectly connected to the external electronic apparatus through the server.

In an embodiment of the disclosure, the electronic apparatus 1000 and the external electronic apparatus may share their electronic apparatus information with each other through the communicator 1200. The plurality of electronic apparatuses may transmit their electronic apparatus information through the communicator 1200 and store the same in the memory 1400 for management or update.

In an embodiment of the disclosure, when the electronic apparatus 1000 determines the external electronic apparatus as an AI service provider apparatus, data about the utterance command by the user may be transmitted to the external electronic apparatus through the communicator 1200.

In an embodiment of the disclosure, when the electronic apparatus 1000 determines to provide server-based AI services, the data about the utterance command by the user may be transmitted to an AI server through the communicator 1200. The electronic apparatus 1000 may request processing of the utterance command by the user to the AI server and receive analysis data of the utterance command by the user from the AI server through the communicator 1200.

The input interface 1300 may include various input circuitry and receive an input by the user for controlling the electronic apparatus 1000 according to the control by the processor 1100. The input interface 1300 may include user input devices of various forms including a touch panel sensing a touch by a user, a button receiving a push operation by a user, a wheel receiving a rotational operation by a user, a key board, a dome switch, a microphone 1310 for voice recognition, a motion sensor sensing a motion, etc.; however, the disclosure is not limited thereto.

In an embodiment of the disclosure, the electronic apparatus 1000 may obtain an utterance command by the user requesting an AI service through the microphone 1310. The utterance command by the user may include voice data. The utterance command by the user according to an embodiment of the disclosure may include specific details of an operation or command requested by the user in relation to the AI service.

However, the disclosure is not limited thereto, and the electronic apparatus 1000 may receive a user command requesting an AI service through a user input device of various forms (e.g., a mouse, a keyboard, a touch panel, etc.) In this case, the utterance command by the user may include text data.

The processor 1100 may be electrically connected with the components included in the electronic apparatus 1000 and may include various processing circuitry and perform calculation or data processing related to control of the components included in the electronic apparatus 1000 and/or communication. According to an embodiment of the disclosure, the processor 1100 may load and process a request, a command, or data received from at least one of other components, and store the processing result data in the memory. According to an embodiment of the disclosure, the processor 1100 may include at least one of a general-purpose processor such as a central processing unit (CPU), an application processor (AP), a digital signal processor (DSP), etc., a graphic processor such as a graphic processing unit (GPU), a vision processing unit (VPU), etc., or an AI-dedicated processor such as a neural processing unit (NPU). The AI-dedicated processor may be a processor specialized in computation of an AI model.

The processor 1100 may process input data or control other components to process input data according to data, operational rules, algorithms, methods, or models stored in the memory 1400. The processor 1100 may perform predefined operational rules, algorithms, methods, or operations of models stored in the memory 1400 using input data.

The memory 1400 may be electrically connected to the processor 1100 and store at least one module, algorithm, operational rule, AI model, program, instruction, or data related to operations of the components included in the electronic apparatus 1000. For example, the memory 1400 may store at least one module, algorithm, operational rule, AI model, program, instruction, or data for processing and control by the processor 1100. The memory 1400 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk; however, the disclosure is not limited thereto.

In an embodiment of the disclosure, the memory 1400 may include a voice pre-processing module 1410, an apparatus determination module 1420, and a command processing module 1430, each of which may include various circuitry and/or executable program instructions. The memory 1400 may store information 1440 of a plurality of electronic apparatuses. The information 1440 of the plurality of electronic apparatuses may include information of the electronic apparatus and information of the external electronic apparatus.

The voice pre-processing module 1410 according to an embodiment of the disclosure may perform pre-processing (e.g., tokenizing) of the utterance command by the user. The pre-processed utterance command by the user may be data used in determining an AI service provider apparatus. For example, the electronic apparatus 1000 may obtain at least one token corresponding to the utterance command by the user by performing tokenizing on the utterance command by the user. The tokenizing may refer to a process of dividing a text or voice data into tokens which are a smaller unit of meaning. The tokenizing may refer to a pre-processing operation performed on data to be input to an NLP model, and through tokenizing, a text or voice may be converted into a form comprehensible by an apparatus. The token may refer to a small unit of meaning extracted from an utterance command by a user. For example, each token may include at least a part of an utterance command by a user.

The voice pre-processing module 1410 according to an embodiment of the disclosure may perform automatic speech recognition (ASR). The electronic apparatus 1000 may convert a speech uttered by a user into an utterance text by through the ASR. The electronic apparatus 1000 may perform the tokenizing using the utterance text by the user. Or, the electronic apparatus 1000 according to an embodiment of the disclosure may tokenize the speech uttered by the user to obtain acoustic or semantic tokens.

The voice pre-processing module 1410 according to an embodiment of the disclosure may identify whether a trigger instruction is included in the utterance command by the user and may perform the tokenizing when the trigger instruction is included. When a trigger instruction such as “Bixby” is included in the utterance command by the user, the electronic apparatus 1000 may perform the tokenizing on the utterance command by the user. However, the disclosure is not limited thereto, and the electronic apparatus 1000 may perform the tokenizing on the utterance command by the user even when no trigger instruction is included.

The apparatus determination module 1420 according to an embodiment of the disclosure may determine an AI service provider apparatus corresponding to the utterance command by the user. The electronic apparatus 1000 may execute at least one instruction stored in the apparatus determination module 1420 to determine an AI service provider apparatus corresponding to the utterance command by the user between the electronic apparatus 1000 and the external electronic apparatus based on the information 1440 of the plurality of electronic apparatus.

Of the information 1440 of the plurality of electronic apparatus according to an embodiment of the disclosure, information of each electronic apparatus may include information used in determining an AI service provider apparatus corresponding to the utterance command by the user. For example, the information of the electronic apparatus may include at least one of device specification information, capability information, on-device AI information, or contents source information.

The electronic apparatus 1000 according to an embodiment of the disclosure may determine an AI service provider apparatus corresponding to the utterance command by the user based on the information of the electronic apparatus 1000 and the information of the external electronic apparatus through the apparatus determination module 1420. For example, the electronic apparatus 1000 may determine an AI service provider apparatus corresponding to the utterance command by the user based on at least one of the device specification information, capability device, on-device AI-related information, and screen contents information of the electronic apparatus 1000 or the device specification information, capability information, on-device AI-related information, and screen contents information of the external electronic apparatus.

For example, the electronic apparatus 1000 may identify device specification required for provision of an AI service corresponding to the utterance command and determine an apparatus that supports such device specification, based on the device specification information of the electronic apparatus 1000 and the device specification information of the external electronic apparatus. For example, the electronic apparatus 1000 may determine an AI service provider apparatus based on at least one of device type information (e.g., PC or monitor), information about at least one processor, information about at least one memory, AI-dedicated processor performance information, AI service type information, on-device AI service information (e.g., whether device-based AI service is supported, whether server-based AI service is supported, and occupancy information of AI-dedicated processor), or on-device AI model performance information.

For example, the electronic apparatus 1000 may select an apparatus capable of providing a capability corresponding to the utterance command by the user, based on the capability information of the electronic apparatus 1000 and the capability information of the external electronic apparatus.

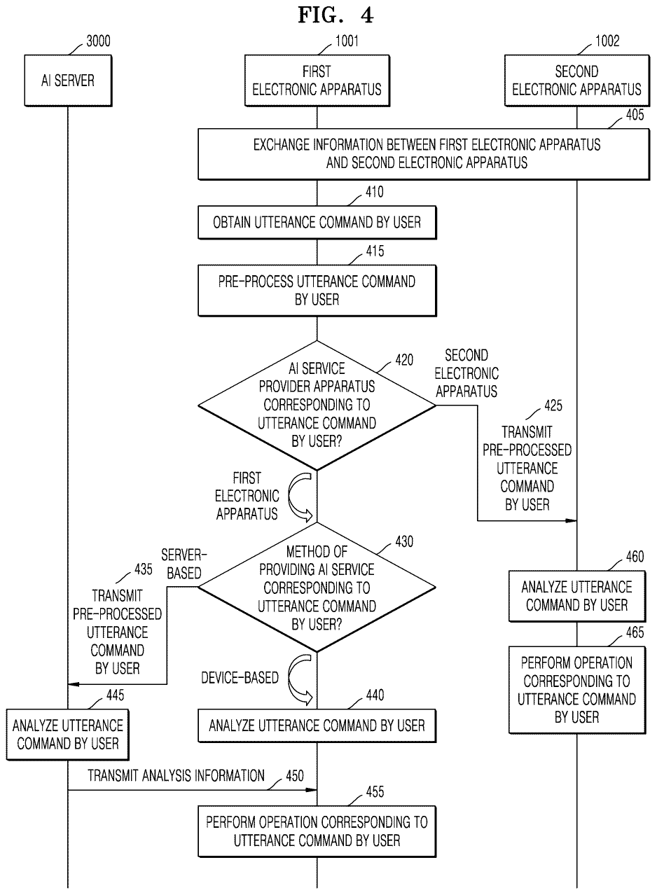

The electronic apparatus 1000 may select an apparatus capable of providing an on-device AI service corresponding to the utterance command by the user, based on the on-device AI-related information of the electronic apparatus 1000 and the on-device AI-related information of the electronic apparatus. For example, the electronic apparatus 1000 may determine an AI service provider apparatus based on at least one of information regarding device-based AI service support, information regarding server-based AI service support, AI-dedicated processor performance information, AI-dedicated processor occupancy information, on-device AI model performance information, or network environment information of the electronic apparatus 1000. The foregoing is described in greater detail below with reference to FIGS. 4 to 6.

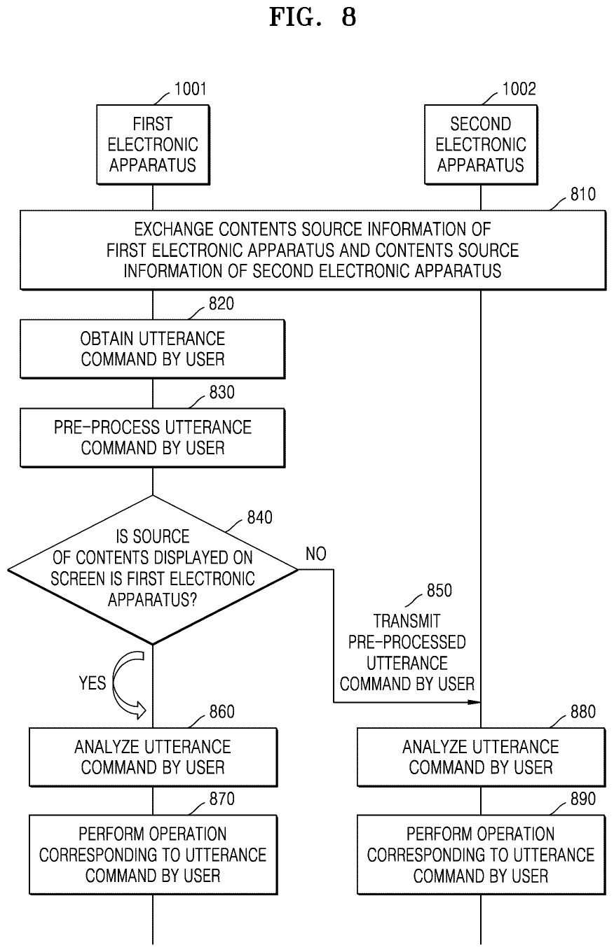

For example, the electronic apparatus 1000 may determine an AI service provider apparatus in response to the utterance command by the user, based on the source information of the contents displayed on the screen of at least one of the electronic apparatus 1000 or the external electronic apparatus. For example, when the contents are displayed on the screen of at least one of the electronic apparatus 1000 or the external electronic apparatus, and the utterance command by the user is related to the contents, the electronic apparatus 1000 may determine a source apparatus generating the contents as an AI service provider apparatus. The foregoing is described in greater detail below with reference to FIGS. 7 and 8.

The apparatus determination module 1420 according to an embodiment of the disclosure may determine a method of providing an AI service provider apparatus corresponding to the utterance command by the user. The electronic apparatus 1000 may execute at least one instruction stored in the apparatus determination module 1420 to determine whether to provide the AI service in a device-based manner or a server-based manner based on the information 1440 of the plurality of electronic apparatuses.

The apparatus determination module 1420 according to an embodiment of the disclosure may determine a microphone activation apparatus receiving the utterance command by the user between the plurality of electronic apparatuses. The electronic apparatus 1000 may execute at least one instruction stored in the apparatus determination module 1420 to determine a microphone activation apparatus receiving the utterance command by the user between the electronic apparatus 1000 and the external electronic apparatus based on the information 1440 of the plurality of electronic apparatus. The foregoing is described in greater detail below with reference to FIGS. 11 to 13.

The command processing module 1430 according to an embodiment of the disclosure may provide an AI service provider apparatus corresponding to the utterance command by the user. In an environment including a plurality of electronic apparatuses, when the electronic apparatus 1000 is determined to be an AI service provider apparatus, the electronic apparatus 1000 may perform an operation for providing an AI service corresponding to the utterance command by the user. The electronic apparatus 1000 may use at least one AI model to grasp an intent included in the utterance command by the user. The electronic apparatus 1000 may execute an AI model using at least one AI-dedicated processor included in the electronic apparatus 1000.

In the environment including the plurality of electronic apparatuses according to an embodiment of the disclosure, when the external electronic apparatus is determined as an AI service provider apparatus, the electronic apparatus 1000 may transmit the utterance command by the user to the external electronic apparatus through the communicator 1200.

In the environment including the plurality of electronic apparatuses according to an embodiment of the disclosure, when the server-based AI service is determined to be provided, the electronic apparatus 1000 may transmit the utterance command by the user to the AI server through the communicator 1200. The electronic apparatus 1000 may receive analysis information of the utterance command by the user from the AI server through the communicator 1200.

According to an embodiment of the disclosure, the command processing module 1430 may be included in a separate server. Or, the command processing module may be included only in the first electronic apparatus, not in the second electronic apparatus.

FIG. 4 is a flowchart illustrating an example method of determining an AI service provider apparatus by an electronic apparatus according to various embodiments. FIG. 4 is a flowchart illustrating an example method of operation in which the plurality of electronic apparatuses provide an AI service based on the first electronic apparatus or the second electronic apparatus according to various embodiments.

Referring to FIG. 4, in operation 405, the first electronic apparatus 1001 and the second electronic apparatus 1002 may exchange electronic apparatus information with each other. That is, the electronic apparatus may store and manage information of the external electronic apparatus in addition to the information of itself. For example, the first electronic apparatus 1001 may transmit the information of the first electronic apparatus 1001 to the second electronic apparatus 1002. The second electronic apparatus 1002 may store and manage the information of the first electronic apparatus 1001 received from the first electronic apparatus 1001 together with the information of the second electronic apparatus 1002. The first electronic apparatus 1001 and the second electronic apparatus 1002 may be connected to the same network and/or user account. As the foregoing is already described above in relation to FIG. 2, any redundant description is omitted.

In operation 410, the first electronic apparatus 1001 may obtain the utterance command by the user. The utterance command by the user according to an embodiment of the disclosure may include specific details of an operation or command requested by the user in relation to the AI service.

In an embodiment of the disclosure, the first electronic apparatus 1001 may obtain an utterance command by the user requesting an AI service through the microphone. The utterance command by the user may include voice data.

The electronic apparatus 1000 according to an embodiment of the disclosure may receive a command by the user requesting an AI service through various types of user input devices (e.g., a mouse, keyboard, touch panel, etc.) In this case, the utterance command by the user may include text data.

The first electronic apparatus 1001 according to an embodiment of the disclosure may be a predetermined apparatus for receiving the utterance command by the user. For example, any one of the microphones included in the first electronic apparatus 1001 and the second electronic apparatus 1002 may be inactivated, and the other one may be activated. The activation of the microphone may be determined based on information about positions between the electronic apparatus and the user, information about the low power mode, contents source information, etc. which are described in greater detail below with reference to FIG. 11.

In operation 415, the first electronic apparatus 1001 may perform pre-processing on the utterance command by the user. Operation 415 may correspond to the operation of the voice pre-processing module 1410 in FIG. 3.

The first electronic apparatus 1001 according to an embodiment of the disclosure may convert the speech uttered by the user into an utterance text through automatic speech recognition (ASR). The first electronic apparatus 1001 may obtain at least one token through the tokenizing of the utterance command by the user. The at least one token may be data used in determining an AI service provider apparatus.

The utterance command by the user according to an embodiment of the disclosure may include a trigger instruction. For example, when a trigger instruction such as “Bixby” is included in the utterance command by the user, the first electronic apparatus 1001 may perform the tokenizing on the utterance command by the user. However, the disclosure is not limited thereto, and the electronic apparatus 1000 may perform the tokenizing on the utterance command by the user and perform operation 420 and operations subsequent thereto even when no trigger instruction is included.

In operation 420, the first electronic apparatus 1001 may determine an AI service provider apparatus corresponding to the utterance command by the user based on the utterance command by the user, the information of the first electronic apparatus 1001, and the information of the second electronic apparatus 1002. The first electronic apparatus 1001 according to an embodiment of the disclosure may determine at least one of the first electronic apparatus 1001 or the second electronic apparatus 1002 as an AI service provider apparatus.

The information of the electronic apparatus according to an embodiment of the disclosure may include information used in determining an AI service provider apparatus corresponding to the utterance command by the user. For example, the information of the electronic apparatus may include at least one of device specification information, capability information, on-device AI information, or contents source information.

The first electronic apparatus 1001 according to an embodiment of the disclosure may determine an AI service provider apparatus corresponding to the utterance command by the user based on at least one of the device specification information, the capability information, the on-device AI-related information, and the screen contents information of the first electronic apparatus 1001 or the device specification information, the capability information, the on-device AI-related information, and the screen contents information of the second electronic apparatus 1002.

For example, the first electronic apparatus 1001 may determine as an AI service provider apparatus an apparatus including a processor with excellent performance, an apparatus including memory with large capacity, an apparatus including an AI-dedicated processor (e.g., NPU) with excellent performance, an apparatus providing a device-based AI service, an apparatus including an AI-dedicated processor (e.g., NPU) with low current occupancy (i.e., apparatus with high remaining amount of resource), an apparatus including an on-device AI model with excellent performance, or an apparatus with stable network environment.

Operation 420 may correspond to the operation of the apparatus determination module 1420 in FIG. 3 and is already described in detail in relation to FIG. 3 and thus may not be repeated here.

In operations 420 and 425, when the second electronic apparatus 1002 is determined as an AI service provider apparatus, the first electronic apparatus 1001 may transmit the pre-processed utterance command by the user to the second electronic apparatus 1002. For example, the pre-processed utterance command by the user may include at least one token. The second electronic apparatus 1002 may receive the pre-processed utterance command by the user. In operations 460 and 465, the second electronic apparatus 1002 may analyze the pre-processed utterance command by the user and perform an operation corresponding to the utterance command by the user using at least one AI model. As the foregoing corresponds to operations 440 and 455, further description thereof is to be provided in greater detail below.

In operations 420 and 430, when the first electronic apparatus 1001 is determined as an AI service provider apparatus, the first electronic apparatus 1001 may determine a method of providing an AI service corresponding to the utterance command by the user based on the utterance command by the user, the information of the first electronic apparatus 1001, and the information of the second electronic apparatus 1002. The first electronic apparatus 1001 according to an embodiment of the disclosure may determine whether to provide a device-based AI service or a server-based AI service.

The information of the electronic apparatus according to an embodiment of the disclosure may include information used in determining a method of providing an AI service provider apparatus corresponding to the utterance command by the user. For example, the first electronic apparatus 1001 may determine whether to provide an AI service provider apparatus corresponding to the utterance command by the user in a device-based manner or a server-based manner, based on at least one of the device specification information, the capability information, the on-device AI-related information, and the screen contents information of the first electronic apparatus 1001 or the device specification information, the capability information, the on-device AI-related information, and the screen contents information of the second electronic apparatus 1002.

For example, when the AI service provider apparatus does not support an on-device AI service, the provision method may be determined to be server-based. For example, when the network environment is offline, the provision method may be determined to be device-based. For example, when the AI model has excellent performance, and the user desires high-speed operation processing, the provision method may be determined to be server-based. When the remaining amount of NPU resources is small, the provision amount may be determined to be server-based. For example, when the AI service provider apparatus subscribes to paid server-based AI services, the provision method may be determined to be server-based. However, the disclosure is not limited thereto.

In operations 430 and 435, when the first electronic apparatus 1001 determined to provide the AI service in a server-based manner, the pre-processed utterance command by the user may be transmitted to an AI server 3000. For example, the pre-processed utterance command by the user may include at least one token. The AI server 3000 may be a cloud server with an AI model. The AI server 3000 may be identical to or different from the server 2000 of FIG. 2. The AI server 3000 may receive the pre-processed utterance command by the user. In operation 445, the AI server 3000 may analyze the pre-processed utterance command by the user using at least one AI model. The operation of analyzing the utterance command by the user is to be further described in relation to operation 440. In operation 450, the AI server 3000 may transmit the analysis information to the first electronic apparatus 1001. The first electronic apparatus 1001 may receive the analysis information from the AI server 3000 and perform an operation corresponding to the analysis information.

In operations 430, 440, and 455, when the first electronic apparatus 1001 determines to provide a device-based AI service, the first electronic apparatus 1001 may operate to provide an AI service corresponding to the utterance command by the user. Operations 440 and 455 may correspond to the operations of command processing module 1430 of FIG. 3.

In operation 440, the first electronic apparatus 1001 may use at least one AI model to grasp an intent included in the utterance command by the user. For example, the first electronic apparatus 1001 may user natural language processing (NLP) and/or natural language understanding (NLU). The first electronic apparatus 1001 may grasp the meaning, context, intent, etc. of words in a sentence by performing an analysis on the tokenized utterance command by the user. The utterance command by the user may be interpreted through an NLP and/or NLU model and may be extracted as information, numerical values, parameters, etc. representing the intent of the utterance by the user. In operation 455, the first electronic apparatus 1001 may perform an operation corresponding to the utterance command by the user based on the analyzed information.

Operations 430 and 435 may be omitted from the operating method of the electronic apparatus according to an embodiment of the disclosure. For example, the determination of the AI service provision method may be omitted and may be performed separately from the operation of determining an AI service provider apparatus. For example, when the first electronic apparatus 1001 is determined to be an AI service provider apparatus, the first electronic apparatus 1001 may operate to provide an AI service corresponding to the utterance command by the user. When the second electronic apparatus 1002 is determined to be an AI service provider apparatus, the first electronic apparatus 1001 may transmit the utterance command by the user to the second electronic apparatus 1002.

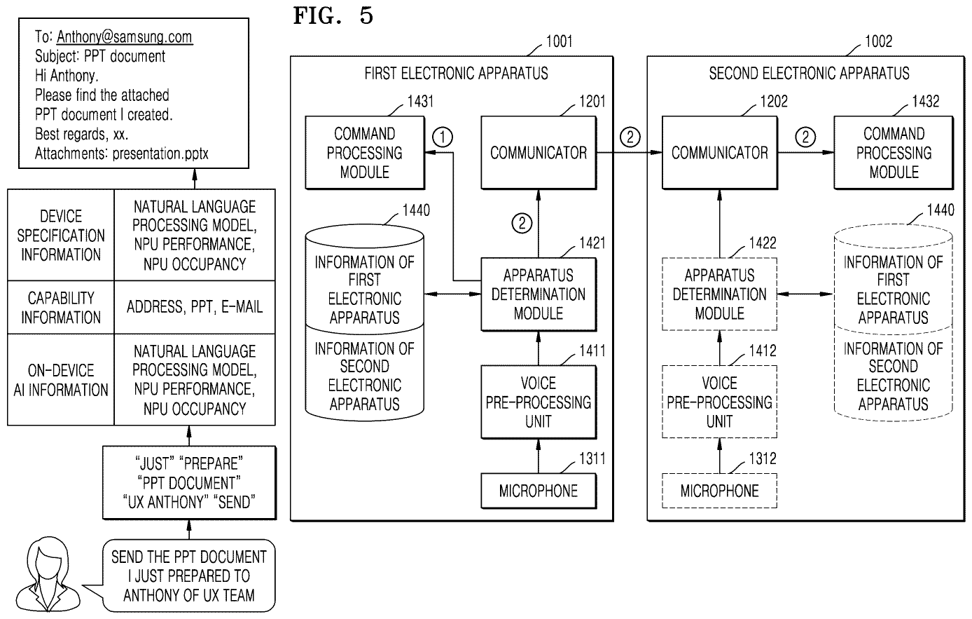

FIG. 5 is a diagram illustrating an example operation of providing by a first electronic apparatus an AI service according to an utterance command, based on the first electronic apparatus or a second electronic apparatus according to various embodiments.

FIG. 5 illustrates the operation of determining an AI service provider apparatus by the first electronic apparatus 1001 by receiving the utterance command by the user. The operation of determining the first electronic apparatus 1001 as an AI service provider apparatus and the operation of determining the second electronic apparatus 1002 as an AI service provider apparatus by the first electronic apparatus 1001 are to be described separately.

The first electronic apparatus 1001 according to an embodiment of the disclosure may include a microphone 1311, a voice pre-processing module 1411, an apparatus determination module 1421, a command processing module 1431, wherein each of the modules may include various circuitry and/or executable program instructions and a communicator (e.g., including communication circuitry) 1201. The first electronic apparatus 1001 may store the information 1440 of the plurality of electronic apparatuses. The second electronic apparatus 1002 according to an embodiment of the disclosure may include a microphone 1312, a voice pre-processing module 1412, an apparatus determination module 1422, a command processing module 1432, wherein each of the modules may include various circuitry and/or executable program instructions, and a communicator (e.g., including communication circuitry) 1202. The second electronic apparatus 1002 may store the information 1440 of the plurality of electronic apparatuses. The foregoing components correspond to the microphone 1310, the voice pre-processing module 1410, the apparatus determination module 1420, the command processing module 1430, the communicator 1200 of the electronic apparatus 1000 of FIG. 3, and the information 1440 of the plurality of electronic apparatuses, respectively.

The first electronic apparatus 1001 may receive the utterance command by the user through the microphone 1311. For example, the first electronic apparatus 1001 may receive an utterance command such as “send the PPT document I just prepared to Anthony of UX team.”

The first electronic apparatus 1001 may perform pre-processing on the utterance command by the user through the voice pre-processing module 1411. For example, the first electronic apparatus 1001 may tokenize the utterance command and generate tokens such as “just,” “prepare,” “PPT document,” “UX Anthony,” “send,” etc.

The first electronic apparatus 1001 may determine whether to decide the first electronic apparatus 1001 or the second electronic apparatus 1002 as an AI service provider apparatus based on the information 1440 of the plurality of electronic apparatus, through the apparatus determination module 1421. For example, the first electronic apparatus 1001 may identify required device specification information (e.g., NPU performance, NPU occupancy, on-device AI service support, etc.), required types of AI service (e.g., NLP), and required capability information (e.g., PPT document program, e-mail program, and address program), etc. For example, the first electronic apparatus 1001 may match the information identified in correspondence with the utterance command by the user with the information 1440 of the plurality of electronic apparatuses. The first electronic apparatus 1001 may identify whether each electronic apparatus is capable of executing a device-based NLP model, the NPU performance of each electronic apparatus, the NPU occupancy of each electronic apparatus, etc., based on the information 1440 of the plurality of electronic apparatuses. In addition, the first electronic apparatus 1001 may identify an apparatus having the capability corresponding to the PPT document program, e-mail program, address program, etc., based on the information 1440 of the plurality of electronic apparatuses.

When the first electronic apparatus 1001 is determined as an AI service provider apparatus through the apparatus determination module 1421, the first electronic apparatus 1001 may transmit the token data to the command processing module 1431. The first electronic apparatus 1001 may provide a device-based AI service. The first electronic apparatus 1001 may execute an AI model through the command processing module 1431 and provide AI services by executing at least one application (or program) related to the AI services. For example, the first electronic apparatus 1001 may graphs an intent included in the utterance command by the user and perform a context analysis through the natural language processing. The first electronic apparatus 1001 may execute a PPT document program, an e-mail program, and an address program based on the intent of the user. The first electronic apparatus 1001 may perform operations of identifying the stored PPT document, identifying the address of Anthony of UX team, and sending the identified PPT document to Anthony via e-mail.

When the second electronic apparatus 1002 is determined as an AI service provider apparatus through the apparatus determination module 1421, the first electronic apparatus 1001 may transmit the token data to the second electronic apparatus 1002 through the communicator 1201. The second electronic apparatus 1002 may receive the token data through the communicator 1202 and perform an operation of providing an AI service corresponding to the utterance command by the user through the command processing module 1432. In this case, the microphone 1312, the voice pre-processing module 1412, and the apparatus determination module 1422 may not operate; however, the disclosure is not limited thereto.

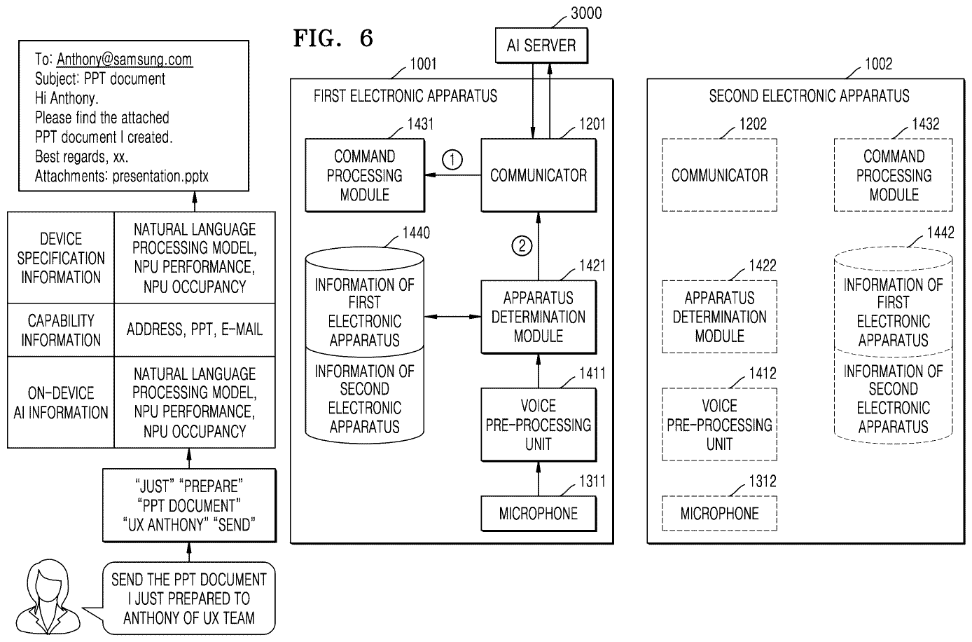

FIG. 6 is a diagram illustrating an example operation of providing by a first electronic apparatus an AI service according to an utterance command, based on a server according to various embodiments.

The operation of determining the first electronic apparatus 1001 as an AI service provider apparatus and providing a server-based AI service by the first electronic apparatus 1001 is described in relation to FIG. 6. Any description which has already been made with reference to FIG. 5 may not be repeated here.

The first electronic apparatus 1001 may determine a method of providing an AI service to be server-based through the apparatus determination module 1421. For example, when the current NPU occupancy is high, or the NPU performance is low, the first electronic apparatus 1001 may provide an AI service in a server-based manner. The first electronic apparatus 1001 may transmit the token data to the AI server 3000 through the communicator 1201. The token data is input to the AI model of the AI server 3000, and analysis information of the utterance command may be extracted from the AI model. The first electronic apparatus 1001 may receive the analysis information of the utterance command from the AI server 3000 through the communicator 1201.

The first electronic apparatus 1001 may provide an AI service by executing at least one application (program) related to the AI service through the command processing module 1431 and the analysis information of the utterance command received from the AI server 3000. The first electronic apparatus 1001 may provide a server-based AI service. For example, the first electronic apparatus 1001 may execute a PPT document program, an e-mail program, and an address program and deliver related data based on the intent of the user. The first electronic apparatus 1001 may perform operations of identifying the stored PPT document, identifying the address of Anthony of UX team, and sending the identified PPT document to Anthony via e-mail. In this case, as the second electronic apparatus 1002 does not operate, the AI service may be provided efficiently.

Hereinafter, an operation of determining an AI service provider apparatus by the electronic apparatus 1000 according to an embodiment of the disclosure based on the content source information is described in greater detail below with reference to FIGS. 7 to 10.

FIG. 7 is a flowchart illustrating an example method of determining an AI service provider apparatus by an electronic apparatus based on contents source information according to various embodiments. The electronic apparatus 1000 of FIG. 7 may be any one of the plurality of electronic apparatuses 1001 and 1002 illustrated in FIGS. 1, 2, 4, 5, and 6. The external electronic apparatus may be the other one of the plurality of electronic apparatuses 1001 and 1002.

Referring to FIG. 7, in operation 710, the electronic apparatus 1000 may obtain the utterance command by the user.

The utterance command by the user according to an embodiment of the disclosure may include specific details of an operation or command requested by the user in relation to the AI service. In an embodiment of the disclosure, the electronic apparatus 1000 may obtain an utterance command by the user requesting an AI service through the microphone. The utterance command by the user may include voice data. The foregoing is as described above in relation to operation 410 of FIG. 4.

The electronic apparatus 1000 according to an embodiment of the disclosure may convert the utterance command by the user into the utterance text through automatic speech recognition (ASR). The electronic apparatus 1000 may obtain at least one token through the tokenizing of the utterance command by the user. The at least one token may be data used in determining an AI service provider apparatus. The foregoing is as described above in relation to the voice pre-processing module 1410 of FIG. 3 and operation 415 of FIG. 4.

The electronic apparatus 1000 according to an embodiment of the disclosure may be a predetermined apparatus for receiving the utterance command by the user. For example, any one of the microphones included in the electronic apparatus 1000 and the external electronic apparatus may be inactivated, and the other one may be activated. The activation of the microphone may be determined based on information about positions between the electronic apparatus and the user, information about the low power mode, contents source information, etc. which are to be described later in relation to FIG. 11.

In operation 720, the electronic apparatus 1000 may determine an AI service provider apparatus based on the source information of the contents displayed on the screen and the utterance command by the user.

In an embodiment of the disclosure, contents may be displayed on the screen of at least one of the electronic apparatus 1000 or the external electronic apparatus. The electronic apparatus 1000 may store the source information of the contents displayed on the screen of at least one of the electronic apparatus 1000 or the external electronic apparatus. For example, the electronic apparatus 1000 may store at least one of the contents source information of the electronic apparatus 1000 or the contents source information of the external electronic apparatus. The contents source information of the external electronic apparatus may be received from the external electronic apparatus and stored in the memory of the electronic apparatus 1000. The electronic apparatus 1000 and the external electronic apparatus may be connected via a network and/or to the same user account and may share contents source information with each other. The foregoing is already described above in relation to FIG. 2.

The electronic apparatus 1000 according to an embodiment of the disclosure may determine an AI service provider apparatus corresponding to the utterance command by the user, based on the source information of the contents displayed on the screen of at least one of the electronic apparatus 1000 or the external electronic apparatus. For example, when the contents are displayed on the screen of at least one of the electronic apparatus 1000 or the external electronic apparatus, the electronic apparatus 1000 may determine a source apparatus generating the contents as an AI service provider apparatus.

For example, when the contents are displayed on the screen of the external electronic apparatus, the electronic apparatus 1000 may identify the source information of the contents displayed on the screen of the external electronic apparatus. When the source of the contents displayed on the external electronic apparatus is the electronic apparatus 1000, the electronic apparatus 1000 may determine the electronic apparatus 1000 itself as an AI service provider apparatus. When the source of the contents displayed on the external electronic apparatus is the external electronic apparatus, the electronic apparatus 1000 may determine the external electronic apparatus as an AI service provider apparatus.

When the contents are displayed on the screen of the electronic apparatus 1000, the electronic apparatus 1000 may identify the source information of the contents displayed on the screen of the electronic apparatus 1000. When the source of the contents displayed on the electronic apparatus 1000 is the electronic apparatus 1000, the electronic apparatus 1000 may determine the electronic apparatus 1000 itself as an AI service provider apparatus. When the source of the contents displayed on the electronic apparatus 1000 is the external electronic apparatus, the electronic apparatus 1000 may determine the external electronic apparatus as an AI service provider apparatus.

In an embodiment of the disclosure, when the utterance command by the user is related to the control of the contents, it may be efficient for the source apparatus generating the content to control the contents. The sink apparatus may need to request additional data from the source apparatus or require additional communication to perform an operation of controlling the contents. On the contrary, when the source apparatus performs the operation of contents control, the operation may be carried out immediately without unnecessary transmission of data. In addition, when the utterance command by the user is related to the contents, the source apparatus may understand the context and intent of the command more easily. For example, when the user command is “store the video I am watching,” as the sink apparatus is simply outputting the video, the sink apparatus may have information about a storage location or format. On the contrary, as the source apparatus is the one generating the video, the source apparatus may process the command more accurately.

The electronic apparatus 1000 according to an embodiment of the disclosure may identify whether the utterance command by the user is related to the contents. For example, the electronic apparatus 1000 may identify whether contents-related keywords are included in the tokenized utterance command by the user. The electronic apparatus 1000 may identify the source information of the contents only when the contents-related keywords are included in the tokenized utterance command by the user. However, the disclosure is not limited thereto, and even when the contents-related keywords are not included in the tokenized utterance command by the user, the electronic apparatus 1000 may identify the source information of the contents comprehensively and determine an AI service provider apparatus using the source information of the contents. When the contents are displayed, it is highly likely that the user makes a contents-s related request, the electronic apparatus 1000 may use the source information of the contents in a comprehensive manner.

The electronic apparatus 1000 according to an embodiment of the disclosure may determine at least one of the plurality of electronic apparatuses as an AI service provider apparatus based on the information of the plurality of electronic apparatuses (e.g., device specification information, capability information, on-device AI-related information, etc.) in addition to the source information of the contents. The foregoing is as described above in relation to the apparatus determination module 1420 of FIG. 3 and operation 420 of FIG. 4.

The electronic apparatus 1000 according to an embodiment of the disclosure may determine a method of providing an AI service (e.g., device-based, server-based, etc.) using the information of the plurality of electronic apparatuses (e.g., device specification information, capability information, on-device AI-related information, contents source information, etc.) The foregoing is as described above in relation to the apparatus determination module 1420 of FIG. 3 and operation 430 of FIG. 4.

In operation 730, the electronic apparatus 1000 may control the electronic apparatus 1000 to perform an operation corresponding to the utterance command by the user through an AI service provider apparatus. For example, when the electronic apparatus 1000 is determined as an AI service provider apparatus, the electronic apparatus 1000 may process the utterance command by the user to perform an operation corresponding to the utterance command by the user. The foregoing is as described above in relation to the command processing module 1430 of FIG. 3 and operations 440 and 455 of FIG. 4. When the external electronic apparatus is determined as an AI service provider apparatus, the electronic apparatus 1000 may control the communicator to transmit the utterance command by the user to the external electronic apparatus.

When the contents are displayed on the screen of the external electronic apparatus, the electronic apparatus 1000 according to an embodiment of the disclosure may determine the external electronic apparatus as an AI service provider apparatus when the contents source of the external electronic apparatus is the external electronic apparatus and transmit the utterance command by the user to the external electronic apparatus through the communicator. When the contents source of the external electronic apparatus is the electronic apparatus 1000, the electronic apparatus 1000 may determine the electronic apparatus 1000 as an AI service provider apparatus and perform an operation corresponding to the utterance command by the user.

When the contents are displayed on the screen of the electronic apparatus 1000, the electronic apparatus 1000 according to an embodiment of the disclosure may determine the electronic apparatus 1000 as an AI service provider apparatus when the contents source of the electronic apparatus 1000 is the electronic apparatus 1000 and may perform an operation corresponding to the utterance command by the user. The electronic apparatus 1000 may determine the external electronic apparatus as an AI service provider apparatus when the contents source of the electronic apparatus 1000 is the external electronic apparatus and transmit the utterance command by the user to the external electronic apparatus through the communicator.

FIG. 8 is a flowchart illustrating an example method of providing an AI service by a first electronic apparatus and a second electronic apparatus based on contents source information according to various embodiments.

Referring to FIG. 8, in operation 810, the first electronic apparatus 1001 and the second electronic apparatus 1002 may exchange contents source information with each other. For example, the first electronic apparatus 1001 may store at least one of the source information of the contents displayed on the screen of the first electronic apparatus 1001 or the source information of the contents displayed on the screen of the second electronic apparatus 1002. The first electronic apparatus 1001 and the second electronic apparatus 1002 may be connected to the same network and/or user account. As the foregoing is already described above in relation to FIG. 2, any redundant description may not be repeated here.

In operation 820, the first electronic apparatus 1001 may obtain the utterance command by the user. Operation 820 may correspond to operation 410 of FIG. 4.

In operation 830, the first electronic apparatus 1001 may perform pre-processing on the utterance command by the user. Operation 830 may correspond to operation 415 of FIG. 4.

In operation 840, the first electronic apparatus 1001 may identify the source information of the contents displayed on the screen of at least one of the first electronic apparatus 1001 or the second electronic apparatus 1002. In operations 840 and 850, when the source of the contents displayed on the screen of at least one of the first electronic apparatus 1001 or the second electronic apparatus 1002 is the second electronic apparatus 1002, the first electronic apparatus 1001 may transmit the pre-processed utterance command by the user to the second electronic apparatus 1002. The second electronic apparatus 1002 may receive the pre-processed utterance command by the user. In operations 880 and 890, the second electronic apparatus 1002 may analyze the pre-processed utterance command by the user and perform an operation corresponding to the utterance command by the user using at least one AI model. Operations 880 and 890 may correspond to operations 860 and 870.

In operations 840 and 860, when the source of the contents displayed on the screen of at least one of the first electronic apparatus 1001 or the second electronic apparatus 1002 is the first electronic apparatus 1001, the first electronic apparatus 1001 may process the utterance command by the user to through the first electronic apparatus 1001.

In operations 860 and 870, when the first electronic apparatus 1001 is determined to be an AI service provider apparatus, the first electronic apparatus 1001 may operate to provide an AI service corresponding to the utterance command by the user. In operation 860, the first electronic apparatus 1001 may use at least one AI model to grasp an intent included in the utterance command by the user. In operation 870, the first electronic apparatus 1001 may perform an operation corresponding to the utterance command by the user based on the analyzed information. Operations 860 and 870 may correspond to operations 440 and 455 of FIG. 4.

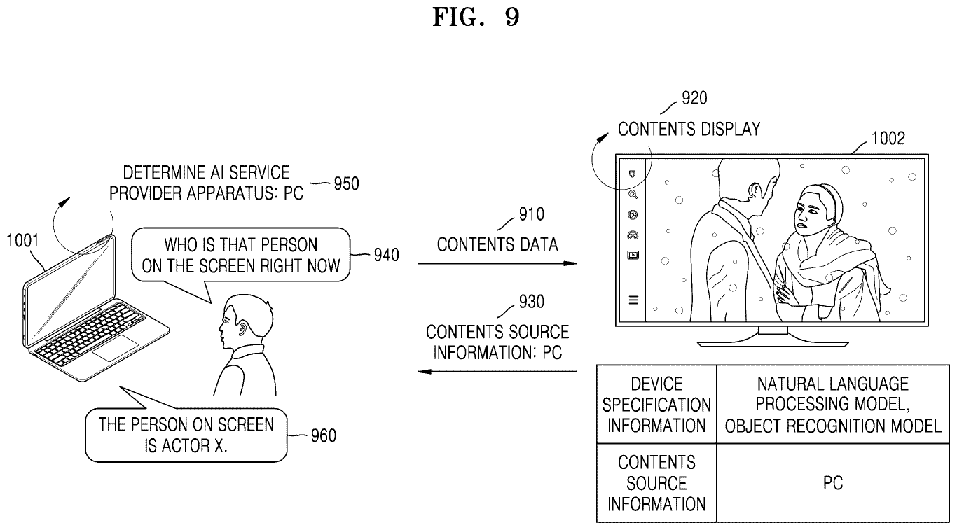

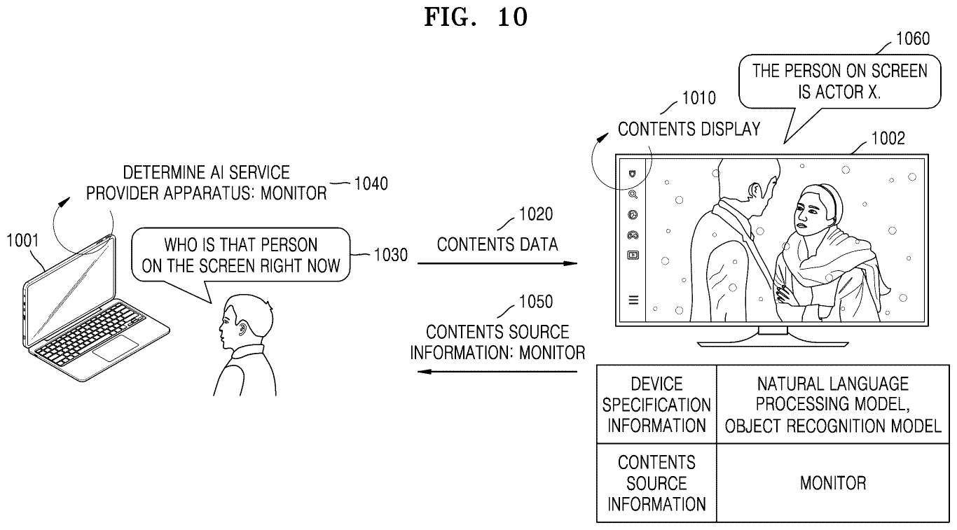

Referring to FIGS. 9 and 10, the operation of determining an AI service provider apparatus by the first electronic apparatus 1001 when the first electronic apparatus 1001 receives the utterance command by the user, and the second electronic apparatus 1002 displays the contents is described. Although the first electronic apparatus 1001 is illustrated as a PC, and the second electronic apparatus 1002 is illustrated as a monitor, the disclosure is not limited thereto.

FIG. 9 is a diagram illustrating an example operation of providing an AI service by a first electronic apparatus based on contents source information of a second electronic apparatus according to various embodiments. In FIG. 9, the contents source of the second electronic apparatus 1002 may be the first electronic apparatus 1001.

In operation 910, the first electronic apparatus 1001 may transmit contents data to the second electronic apparatus 1002. In operation 920, the second electronic apparatus 1002 may receive the contents data and display the contents on the screen. In this case, the first electronic apparatus 1001 and the second electronic apparatus 1002 may be connected to each other via wireless connection such as mirroring, casting, etc. or wired connection using a cable (e.g., HDMI). The first electronic apparatus 1001 may be a source apparatus transmitting the contents to the second electronic apparatus 1002, and the second electronic apparatus 1002 may be a sink apparatus outputting the received contents.

In operation 930, the second electronic apparatus 1002 may transmit to the first electronic apparatus 1001 the contents source information that the contents source of the first electronic apparatus 1001. The second electronic apparatus 1002 may share the contents source information with the first electronic apparatus 1001 periodically or every time the source of the contents changes. The first electronic apparatus 1001 and the second electronic apparatus 1002 may prestore their contents source information.

In operation 940, the first electronic apparatus 1001 may receive the utterance command by the user. For example, the first electronic apparatus 1001 may receive an utterance command such as “who is that person on the screen right now.” The first electronic apparatus 1001 may generate tokens such as “screen,” “person,” “who,” etc. In operation 950, as the contents source of the second electronic apparatus 1002 is the first electronic apparatus 1001, the first electronic apparatus 1001 may determine the first electronic apparatus 1001 itself as an AI service provider apparatus. In addition, the first electronic apparatus 1001 may identify types of necessary AI services (e.g., natural language processing, object recognition, etc.) based on the tokens. As the first electronic apparatus 1001 prestores device specification information, capability information, on-device AI-related information, etc., the first electronic apparatus 1001 may determine whether necessary AI services can be supported and determine the first electronic apparatus 1001 as an AI service provider apparatus.

In operation 960, the first electronic apparatus 1001 may analyze the utterance command by the user through the natural language processing model and perform an operation of recognizing an object on a screen through the object recognition model to provide an AI service. For example, the first electronic apparatus 1001 may output a response such as “the person on the screen is actor X.” The response may be output in a form of voice data, text data, etc. through an output interface such as a speaker, a display, etc.

FIG. 10 is a diagram illustrating an example operation of providing an AI service by a first electronic apparatus based on contents source information of a second electronic apparatus according to various embodiments. In FIG. 10, the contents source of the second electronic apparatus 1002 may be the second electronic apparatus 1002.

In operation 1010, the second electronic apparatus 1002 may display contents on the screen. The second electronic apparatus 1002 may be an apparatus including an operating system (OS) and internet connection function. For example, the second electronic apparatus 1002 may execute an over-the-top (OTT) application using an OS included therein to output the contents. In this case, the source of the contents displayed on the screen of the second electronic apparatus 1002 may be the second electronic apparatus 1002 itself.

In operation 1020, the second electronic apparatus 1002 may transmit to the first electronic apparatus 1001 the contents source information that the contents source of the second electronic apparatus 1002. The second electronic apparatus 1002 may share the contents source information with the first electronic apparatus 1001 periodically or every time the source of the contents changes. The first electronic apparatus 1001 and the second electronic apparatus 1002 may prestore their contents source information.

In operation 1030, the first electronic apparatus 1001 may receive the utterance command by the user. For example, the first electronic apparatus 1001 may receive an utterance command such as “who is that person on the screen right now.” The first electronic apparatus 1001 may generate tokens such as “screen,” “person,” “who,” etc. In operation 1040, as the contents source of the second electronic apparatus 1002 is the second electronic apparatus 1002, the first electronic apparatus 1001 may determine the second electronic apparatus 1002 as an AI service provider apparatus. In addition, the first electronic apparatus 1001 may identify types of necessary AI services (e.g., natural language processing, object recognition, etc.) based on the tokens. As the first electronic apparatus 1001 and the second electronic apparatus 1002 prestore their device specification information, capability information, on-device AI-related information, etc., the first electronic apparatus 1001 may identify whether the second electronic apparatus 1002 can supports necessary AI services and then determine the second electronic apparatus 1002 as an AI service provider apparatus. In operation 1050, the first electronic apparatus 1001 may transmit the utterance command by the user to the second electronic apparatus 1002. The second electronic apparatus 1002 may receive the utterance command by the user.

In operation 1060, the second electronic apparatus 1002 may analyze the utterance command by the user through the natural language processing model and perform the operation of recognizing an object on the screen through the object recognition model to provide an AI service. For example, the second electronic apparatus 1002 may output a response such as “the person on the screen is actor X.” The response may be output in a form of voice data, text data, etc. through an output interface such as a speaker, a display, etc.

Hereinafter, an operation of determining a microphone activation apparatus and an AI service provider apparatus by the electronic apparatus 1000 according to an embodiment of the disclosure based on the contents source information is described in greater detail below with reference to FIGS. 11 to 13.

FIG. 11 is a flowchart illustrating an example method of determining a microphone activation apparatus and an AI service provider apparatus by an electronic apparatus according to various embodiments. The electronic apparatus 1000 of FIG. 11 may be any one of the plurality of electronic apparatuses 1001 and 1002 illustrated in FIGS. 1, 2, 4, 5, 6, 9, and 10. The external electronic apparatus may be the other one of the plurality of electronic apparatuses 1001 and 1002.

Referring to FIG. 11, in operation 1110, the electronic apparatus 1000 may determine to activate the microphone of at least one of the electronic apparatus 1000 or the external electronic apparatus.

In an embodiment of the disclosure, the electronic apparatus 1000 and the external electronic apparatus may each include a microphone. In this case, instead of activating both of the electronic apparatus 1000 and the external electronic apparatus, activating one microphone may be more efficient.

The electronic apparatus 1000 according to an embodiment of the disclosure may determine to activate the microphone of at least one of the electronic apparatus 1000 or the external electronic apparatus based on the information of the plurality of electronic apparatuses. The information of the plurality of electronic apparatuses may include information for determining whether to activate a microphone. For example, the information of the plurality of electronic apparatuses may include at least one of information about locations between the electronic apparatuses and the user, information about low power mode, or contents source information.

For example, the electronic apparatus 1000 may determine to activate the microphone of at least one of the electronic apparatus 1000 or the external electronic apparatus based on the information about the location between the electronic apparatus 1000 and the user. For example, in an environment using a monitor and a PC, when the monitor is located closer to the user, only the microphone of the monitor may be activated, and the microphone of the PC may be inactivated. The information about locations between the users may be predetermined or measured by a distance sensor, etc.

For example, when the electronic apparatus 1000 in the low power mode, to reduce the power consumption, the microphone of at least one of the electronic apparatus 1000 or the external electronic apparatus may be determined to be activated. The electronic apparatus 1000 may determine to activate a microphone of an apparatus connected to the power, an apparatus having high power consumption, or a high-performance apparatus.

The electronic apparatus 1000 may determine to activate the microphone of at least one of the electronic apparatus 1000 or the external electronic apparatus based on the source information of the contents displayed on the screen of at least one of the electronic apparatus 1000 or the external electronic apparatus. When the utterance command by the user is related to the control of the contents, it may be efficient for a source apparatus generating the contents to receive the utterance command by the user. For example, when the contents are displayed on the screen of at least one of the electronic apparatus 1000 or the external electronic apparatus, the electronic apparatus 1000 may activate the microphone of the source apparatus generating the contents.

For example, when the contents are displayed on the screen of the external electronic apparatus, the electronic apparatus 1000 may identify the source information of the contents displayed on the screen of the external electronic apparatus. When the source of the contents displayed on the external electronic apparatus is the electronic apparatus 1000, the electronic apparatus 1000 may determine to activate the microphone of the electronic apparatus 1000. When the source of the contents displayed on the external electronic apparatus is the external electronic apparatus, the electronic apparatus 1000 may determine to activate the microphone of the external electronic apparatus.

When the contents are displayed on the screen of the electronic apparatus 1000, the electronic apparatus 1000 may identify the source information of the contents displayed on the screen of the electronic apparatus 1000. When the source of the contents displayed on the electronic apparatus 1000 is the electronic apparatus 1000, the electronic apparatus 1000 may determine to activate the microphone of the electronic apparatus 1000. When the source of the contents displayed on the electronic apparatus 1000 is the external electronic apparatus, the electronic apparatus 1000 may determine to activate the microphone of the external electronic apparatus.

To activate the microphone of the electronic apparatus 1000, the electronic apparatus 1000 may generate a microphone activation signal for activation of the microphone. In addition, the electronic apparatus 1000 may transmit a microphone inactivation signal to the external electronic apparatus through the communicator to inactivate the microphone of the external electronic apparatus. The external electronic apparatus may receive the microphone inactivation signal from the electronic apparatus 1000 and inactivate the microphone.

To inactivate the microphone of the electronic apparatus 1000, the electronic apparatus 1000 may generate a microphone inactivation signal for inactivation of the microphone. The electronic apparatus 1000 may transmit a microphone activation signal to the external electronic apparatus through the communicator to activate the microphone of the external electronic apparatus. The external electronic apparatus may receive the microphone activation signal from the electronic apparatus 1000 and activate the microphone.

In the disclosure, although a subject determining a microphone activation apparatus is described as the electronic apparatus 1000; the disclosure is not limited thereto. For example, a subject determining the microphone activation apparatus may be the external electronic apparatus or may be a server managing the information of the electronic apparatus 1000 and the external electronic apparatus (e.g., 2000 of FIG. 2).

In operation 1120, when the microphone of the electronic apparatus 1000 is activated, the electronic apparatus 1000 may obtain the utterance command by the user through the microphone. The foregoing is as described above in relation to operation 710 of FIG. 7.

In operation 1130, the electronic apparatus 1000 may determine an AI service provider apparatus based on the utterance command by the user, the information of the electronic apparatus 1000, and the information of the external electronic apparatus. The foregoing is as described above in relation to the apparatus determination module 1420 of FIG. 3.

The electronic apparatus 1000 according to an embodiment of the disclosure may determine an AI service provider apparatus corresponding to the utterance command by the user, based on the source information of the contents displayed on the screen of at least one of the electronic apparatus 1000 or the external electronic apparatus. For example, when the contents are displayed on the screen of at least one of the electronic apparatus 1000 or the external electronic apparatus, the electronic apparatus 1000 may determine a source apparatus generating the contents as an AI service provider apparatus. The foregoing is as described above in relation to the apparatus determination module 1420 of FIG. 3 and operation 720 of FIG. 7.

The electronic apparatus 1000 according to an embodiment of the disclosure may determine at least one of the plurality of electronic apparatuses as an AI service provider apparatus based on the information of the plurality of electronic apparatuses (e.g., device specification information, capability information, on-device AI-related information, etc.) in addition to the source information of the contents. The foregoing is as described above in relation to the apparatus determination module 1420 of FIG. 3 and operation 420 of FIG. 4.

The electronic apparatus 1000 according to an embodiment of the disclosure may determine a method of providing an AI service using the information of the plurality of electronic apparatuses (e.g., device specification information, capability information, on-device AI-related information, contents source information, etc.) The foregoing is as described above in relation to the apparatus determination module 1420 of FIG. 3 and operation 430 of FIG. 4.

In operation 1140, the electronic apparatus 1000 may control the electronic apparatus 1000 to perform an operation corresponding to the utterance command by the user through an AI service provider apparatus.

For example, when the electronic apparatus 1000 is determined as an AI service provider apparatus, the electronic apparatus 1000 may process the utterance command by the user to perform an operation corresponding to the utterance command by the user. The foregoing is as described above in relation to the command processing module 1430 of FIG. 3 and operations 440 and 455 of FIG. 4.

When the external electronic apparatus is determined as an AI service provider apparatus, the electronic apparatus 1000 may control the communicator to transmit the utterance command by the user to the external electronic apparatus.

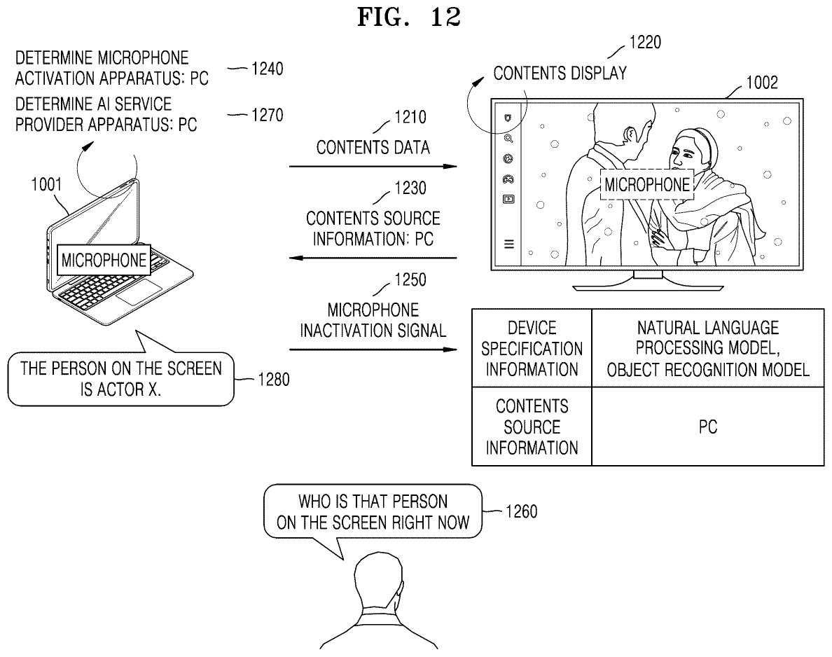

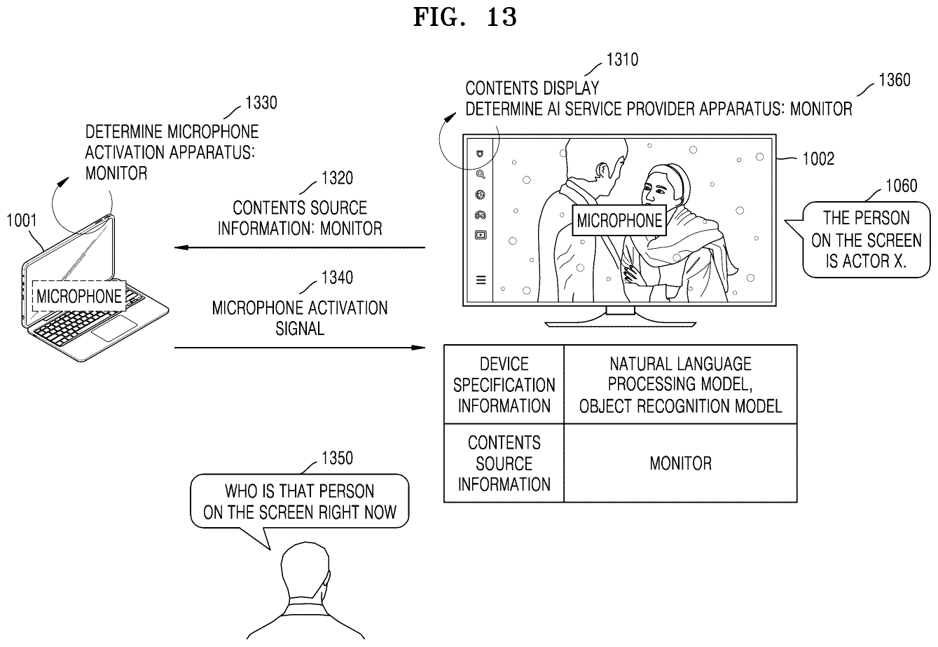

Referring to FIGS. 12 and 13, operations of determining a microphone activation apparatus by the first electronic apparatus 1001 and determining an AI service provider apparatus by the first electronic apparatus 1001 or the second electronic apparatus 1002 when the second electronic apparatus 1002 displays contents are described. Although the first electronic apparatus 1001 is illustrated as a PC, and the second electronic apparatus 1002 is illustrated as a monitor, the disclosure is not limited thereto.

FIG. 12 is a diagram illustrating an example operation of determining a microphone activation apparatus and an AI service provider apparatus by a first electronic apparatus based on contents source information of a second electronic apparatus according to various embodiments. In FIG. 12, the contents source of the second electronic apparatus 1002 may be the first electronic apparatus 1001.

In operation 1210, the first electronic apparatus 1001 may transmit contents data to the second electronic apparatus 1002. In operation 1220, the second electronic apparatus 1002 may receive the contents data and display the contents on the screen. In this case, the first electronic apparatus 1001 and the second electronic apparatus 1002 may be connected to each other via wireless connection such as mirroring, casting, etc. or wired connection using a cable (e.g., HDMI). The first electronic apparatus 1001 may be a source apparatus transmitting the contents to the second electronic apparatus 1002, and the second electronic apparatus 1002 may be a sink apparatus outputting the received contents.

In operation 1230, the second electronic apparatus 1002 may transmit to the first electronic apparatus 1001 the contents source information that the contents source of the first electronic apparatus 1001. The second electronic apparatus 1002 may share the contents source information with the first electronic apparatus 1001 periodically or every time the source of the contents changes. The first electronic apparatus 1001 and the second electronic apparatus 1002 may prestore their contents source information.

In operation 1240, as the contents source of the second electronic apparatus 1002 is the first electronic apparatus 1001, the first electronic apparatus 1001 may determine the first electronic apparatus 1001 itself as a microphone activation apparatus. In operation 1250, the first electronic apparatus 1001 may transmit a microphone inactivation signal to the second electronic apparatus 1002 through the communicator. The microphone of the first electronic apparatus 1001 may be activated, and the microphone of the second electronic apparatus 1002 may be inactivated.

In operation 1260, the first electronic apparatus 1001 may receive the utterance command by the user. For example, the first electronic apparatus 1001 may receive an utterance command such as “who is that person on the screen right now.” The first electronic apparatus 1001 may generate tokens such as “screen,” “person,” “who,” etc. In operation 1270, as the contents source of the second electronic apparatus 1002 is the first electronic apparatus 1001, the first electronic apparatus 1001 may determine the first electronic apparatus 1001 itself as an AI service provider apparatus. In operation 1280, the first electronic apparatus 1001 may analyze the utterance command by the user through the natural language processing model and perform an operation of recognizing an object on a screen through the object recognition model to provide an AI service. For example, the first electronic apparatus 1001 may output a response such as “the person on the screen is actor X.” The response may be output in a form of voice data, text data, etc. through an output interface such as a speaker, a display, etc.

FIG. 13 is a diagram illustrating an example operation of determining a microphone activation apparatus and an AI service provider apparatus by a first electronic apparatus based on contents source information of a second electronic apparatus according to various embodiments. In FIG. 13, the contents source of the second electronic apparatus 1002 may be the first electronic apparatus 1001.

In operation 1310, the second electronic apparatus 1002 may display contents on the screen. The second electronic apparatus 1002 may be an apparatus including an operating system (OS) and internet connection function. For example, the second electronic apparatus 1002 may execute an over-the-top (OTT) application using an OS included therein to output the contents. In this case, the source of the contents displayed on the screen of the second electronic apparatus 1002 may be the second electronic apparatus 1002 itself.

In operation 1320, the second electronic apparatus 1002 may transmit to the first electronic apparatus 1001 the contents source information that the contents source of the second electronic apparatus 1002. The second electronic apparatus 1002 may share the contents source information with the first electronic apparatus 1001 periodically or every time the source of the contents changes. The first electronic apparatus 1001 and the second electronic apparatus 1002 may prestore their contents source information.

In operation 1330, as the contents source of the second electronic apparatus 1002 is the second electronic apparatus 1002, the first electronic apparatus 1001 may determine the second electronic apparatus 1002 as a microphone activation apparatus. In operation 1340, the first electronic apparatus 1001 may transmit a microphone activation signal to the second electronic apparatus 1002 through the communicator. The microphone of the first electronic apparatus 1001 may be inactivated, and the microphone of the second electronic apparatus 1002 may be activated.

In operation 1350, the second electronic apparatus 1002 may receive the utterance command by the user. For example, the second electronic apparatus 1002 may receive an utterance command such as “who is that person on the screen right now.” The second electronic apparatus 1002 may generate tokens such as “screen,” “person,” “who,” etc. In operation 1360, as the contents source of the second electronic apparatus 1002 is the second electronic apparatus 1002, the second electronic apparatus 1002 may determine the second electronic apparatus 1002 as an AI service provider apparatus. In operation 1237, the second electronic apparatus 1002 may analyze the utterance command by the user through the natural language processing model and perform an operation of recognizing an object on a screen through the object recognition model to provide an AI service. For example, the second electronic apparatus 1002 may output a response such as “the person on the screen is actor X.” The response may be output in a form of voice data, text data, etc. through an output interface such as a speaker, a display, etc.

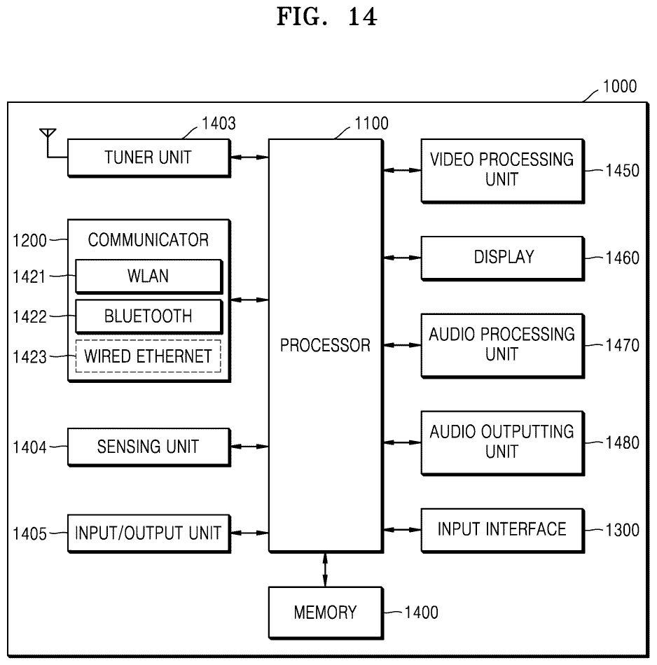

FIG. 14 is a block diagram illustrating an example configuration of an electronic apparatus according to various embodiments.

Referring to FIG. 14, an electronic apparatus 1000 may include a processor (e.g., including processing circuitry) 1100, memory 1400, a tuner unit (e.g., including a tuner) 1403, a communicator (e.g., including communication circuitry) 1200, a sensing unit (e.g., including circuitry) 1404, an input/output unit (e.g., including input/output circuitry)1405, a video processing unit (e.g., including various circuitry and/or executable program instructions) 1450, a display 1460, an audio processing unit (e.g., including various circuitry and/or executable program instructions) 1470, an audio outputting unit (e.g., including audio output circuitry) 1480, and an input interface (e.g., including input circuitry) 1300.

The tuner unit 1403 may include various circuitry and tune and select a frequency of a channel desired to be received by the electronic apparatus 1000 from among numerous radio signal components through amplification, mixing, resonance, etc. of broadcast contents, etc. received in a wired or wireless manner. The contents received through the tuner unit 1403 may be decoded and divided into audio, video, and/or additional information. The divided audio, video, and/or additional information may be stored in the memory 1400 by the control by the processor 1100.

The communicator 1200 may include various communication circuitry and connect the electronic apparatus 1000 to a peripheral device, an external apparatus, a server, a mobile terminal, etc. by the control by the processor 1100. The communicator 1200 may include at least one communication module capable of performing wireless communication. The communicator 1200 may include at least one of a WLAN module 1421, a Bluetooth module 1422, or a wired Ethernet 1423 in correspondence with the performance and structure of the electronic apparatus 1000.

The WLAN module 1421 may receive and transmit a WiFi signal from and to a peripheral apparatus according to WiFi communication standards. The Bluetooth module 1422 may receive a Bluetooth signal transmitted from a peripheral apparatus according to Bluetooth communication standards.

The sensing unit 1404 may include various circuitry and sense a voice of a user, an image of a user, or an interaction of a user and may include a microphone, a camera unit, a light-receiver, and a sensing unit.

The input/output unit 1405 may include various circuitry and receive a video (e.g., dynamic image signal, a still image signal, etc.), audio (e.g., voice signal, music signal, etc.), and additional information from an external apparatus, etc. by the control by the processor 1100. The input/output unit 1405 may include at least one of a high-definition multimedia interface (HDMI) port, a component jack, a PC port, or a USB port. The input/output unit 1405 may further include a display port (DP), a thunderbolt, a mobile high-definition link (MHL), etc. The input/output unit 1405 may further include a port for separate output of video and audio.

The video processing unit 1450 may include various circuitry and/or executable program instructions and process video data to be displayed on the display 1460 and may perform various image processing operations on the video data, such as decoding, rendering, scaling, noise cancelling, noise removal, frame rate converting, and definition converting, etc. For example, the video processing unit 1450 may include various image processing circuits. The video processing unit 1450 may include a media codec for processing image contents.

The display 1460 may receive contents from a broadcasting station or an external apparatus such as an external storage medium, etc. or output on the screen contents provided from various applications, e.g., an OTT service provider, a contents provider, etc. The display 1460 may display image-processed contents.

The audio processing unit 1470 may include various circuitry and/or executable program instructions and perform processing on audio data. The audio processing unit 1470 may perform various processing such as decoding, amplification, noise cancelling, noise removal, etc. in relation to the audio data.

The audio outputting unit 1480 may include various circuitry and output audio included in the content received through the tuner unit 1403, audio input through the communicator 1200 or the input/output unit 1405, and audio stored in the memory 1400 by the control by the processor 1100. The audio outputting unit 1480 may include at least one of a speaker, a headphone, or a Sony/Philips digital interface (S/PDIF).

The input interface 1300 may include various input circuitry and receive an input by the user for controlling the electronic apparatus 1000. The input interface 1300 may include user input devices of various forms including a touch panel sensing a touch by a user, a button receiving a push operation by a user, a wheel receiving a rotational operation by a user, a key board, a dome switch, a microphone for voice recognition, a motion sensor sensing a motion, etc. ; however, the disclosure is not limited thereto.

An electronic apparatus according to an embodiment of the disclosure includes at least one processor including processing circuitry and memory including at least one storage medium storing at least one instruction.

The at least one processor according to an embodiment of the disclosure may individually or collectively execute the at least one instruction to cause the electronic apparatus to obtain an utterance command by a user.

The at least one processor according to an embodiment of the disclosure may individually or collectively execute the at least one instruction to cause the electronic apparatus to determine at least one of the electronic apparatus or an external electronic apparatus as the AI service provider apparatus, based on the utterance command by the user and source information of contents displayed on a screen of at least one of the electronic apparatus or the external electronic apparatus.

The at least one processor according to an embodiment of the disclosure may individually or collectively execute the at least one instruction to cause the electronic apparatus to control the electronic apparatus to perform an operation corresponding to the utterance command by the user through the determined AI service provider apparatus.

The electronic apparatus according to an embodiment of the disclosure may further include a communicator.

The at least one processor according to an embodiment of the disclosure may individually or collectively execute the at least one instruction to cause the electronic apparatus to identify source information of contents displayed on a screen of the external electronic apparatus.

The at least one processor according to an embodiment of the disclosure may individually or collectively execute the at least one instruction to cause the electronic apparatus to transmit the utterance command by the user to the external electronic apparatus through the communicator based on a source of the contents of the external electronic apparatus being the external electronic apparatus.

The at least one processor according to an embodiment of the disclosure may individually or collectively execute the at least one instruction to cause the electronic apparatus to perform an operation corresponding to the utterance command by the user based on the source of the contents of the external electronic apparatus being the electronic apparatus.

The source information of the contents of the external electronic apparatus according to an embodiment of the disclosure may be received from the external electronic apparatus and stored in the memory.

The at least one processor according to an embodiment of the disclosure may individually or collectively execute the at least one instruction to cause the electronic apparatus to identify source information of contents displayed on a screen of the electronic apparatus.

The at least one processor according to an embodiment of the disclosure may individually or collectively execute the at least one instruction to cause the electronic apparatus to perform an operation corresponding to the utterance command by the user based on the source of the contents of the electronic apparatus being the electronic apparatus.

The at least one processor according to an embodiment of the disclosure may individually or collectively execute the at least one instruction to cause the electronic apparatus to transmit the utterance command by the user to the external electronic apparatus through the communicator based on a source of the contents of the electronic apparatus being the external electronic apparatus.

The at least one processor according to an embodiment of the disclosure may individually or collectively execute the at least one instruction to cause the electronic apparatus to analyze a user intent of the utterance command by the user from at least one token corresponding to the utterance command by the user based on the electronic apparatus being determined as the AI service provider apparatus.

The at least one processor according to an embodiment of the disclosure may individually or collectively execute the at least one instruction to cause the electronic apparatus to perform an operation corresponding to the user intent.

The AI service provider apparatus corresponding to the utterance command by the user according to an embodiment of the disclosure may be determined further based on at least one of device specification information of the electronic apparatus, capability information of the electronic apparatus, information regarding on-device AI of the electronic apparatus, device specification information of the external electronic apparatus, capability information of the external electronic apparatus, or information regarding on-device AI of the external electronic apparatus.

The device specification information according to an embodiment of the disclosure may include at least one of device type information, processor information, memory information, performance information of an AI-dedicated processor, AI service type information, information about device-based AI service support, occupancy information of an AI-dedicated processor, or performance information of an on-device AI model.

The at least one processor according to an embodiment of the disclosure may individually or collectively execute the at least one instruction to cause the electronic apparatus to determine to provide an AI service using at least one of a device-based method or a server-based method based on performance information of an AI-dedicated processor, occupancy information of an AI processor, information about device-based AI service support, performance information of an on-device AI model, or network environment information of each of the electronic apparatus and the external electronic apparatus.

The at least one processor according to an embodiment of the disclosure may individually or collectively execute the at least one instruction to cause the electronic apparatus to determine to activate a microphone of at least one of the electronic apparatus or an external electronic apparatus, based on the source information of the contents displayed on the screen of at least one of the electronic apparatus or the external electronic apparatus.

The at least one processor according to an embodiment of the disclosure may individually or collectively execute the at least one instruction to cause the electronic apparatus to determine to activate a microphone of the external electronic apparatus based on the source of the contents of the external electronic apparatus being the external electronic apparatus.

The at least one processor according to an embodiment of the disclosure may individually or collectively execute the at least one instruction to cause the electronic apparatus to determine to activate a microphone of the electronic apparatus based on the source of the contents of the external electronic apparatus being the electronic apparatus.

The at least one processor according to an embodiment of the disclosure may individually or collectively execute the at least one instruction to cause the electronic apparatus to determine to activate at least one of the microphone of the electronic apparatus or the microphone of the external electronic apparatus, based on at least one of positions of the electronic apparatus and the user, positions of the external electronic apparatus and the user, or whether a low power mode is on.

A method of operating an electronic apparatus for determining an AI service provider apparatus according to an embodiment of the disclosure includes obtaining an utterance command by a user, determining at least one of the electronic apparatus or an external electronic apparatus as the AI service provider apparatus, based on the utterance command by the user and source information of contents displayed on a screen of at least one of the electronic apparatus or the external electronic apparatus, and controlling the electronic apparatus to perform an operation corresponding to the utterance command by the user through the determined AI service provider apparatus.

The method according to an embodiment of the disclosure may further include identifying source information of contents displayed on a screen of the external electronic apparatus, transmitting the utterance command by the user to the external electronic apparatus through a communicator based on a source of the contents of the external electronic apparatus being the external electronic apparatus, and performing an operation corresponding to the utterance command by the user based on the source of the contents of the external electronic apparatus being the electronic apparatus.

The source information of the contents of the external electronic apparatus according to an embodiment of the disclosure may be received from the external electronic apparatus and stored in the memory.

The method according to an embodiment of the disclosure may further include identifying source information of contents displayed on a screen of the electronic apparatus, performing an operation corresponding to the utterance command by the user based on a source of the contents of the electronic apparatus is the electronic apparatus, and transmitting the utterance command by the user to the external electronic apparatus through the communicator based on the source of the contents of the electronic apparatus being the external electronic apparatus.

The controlling of the electronic apparatus to perform the operation corresponding to the utterance command by the user according to an embodiment of the disclosure may include analyzing a user intent of the utterance command by the user from at least one token corresponding to the utterance command by the user based on the electronic apparatus being determined as the AI service provider apparatus, and performing an operation corresponding to the user intent.

An AI service provider apparatus corresponding to the utterance command by the user according to an embodiment of the disclosure may be determined further based on at least one of device specification information of the electronic apparatus, capability information of the electronic apparatus, information regarding on-device AI of the electronic apparatus, device specification information of the external electronic apparatus, capability information of the external electronic apparatus, or information regarding on-device AI of the external electronic apparatus.

The device specification information according to an embodiment of the disclosure may include at least one of device type information, processor information, memory information, performance information of an AI-dedicated processor, AI service type information, information about device-based AI service support, occupancy information of an AI-dedicated processor, or performance information of an on-device AI model.

The method according to an embodiment of the disclosure may further include determining to provide an AI service using at least one of a device-based method or a server-based method based on performance information of an AI-dedicated processor, occupancy information of an AI-dedicated processor, information about device-based AI service support, performance information of an on-device AI model, or network environment information of each of the electronic apparatus and the external electronic apparatus.

The method according to an embodiment of the disclosure may further include determining to activate a microphone of at least one of the electronic apparatus or the external electronic apparatus based on the source information of the contents displayed on the screen of at least one of the electronic apparatus or the external electronic apparatus, determining to activate a microphone of the external electronic apparatus based on the source of the contents of the external electronic apparatus being the external electronic apparatus, and determining to activate a microphone of the electronic apparatus based on the source of the contents of the external electronic apparatus being the electronic apparatus.

A non-transitory computer-readable storage medium may be provided as a machine-readable storage medium. The non-transitory storage medium is tangible and may not include signals (e.g., electromagnetic waves), and this term is not intended to distinguish semi-permanent storage of data in a storage medium from temporary storage of the same. For example, the non-transitory storage may include a buffer in which data is temporarily stored.

According to an embodiment of the disclosure, the method described in one or more embodiments of the disclosure may be included and provided in a computer program product. A computer program product may be traded between a seller and a buyer. The computer program may be distributed in the form of a machine-readable storage medium (e.g., compact disc read-only memory; CD-ROM), or distributed (e.g., downloaded or uploaded) online through an application store or directly between two user devices (e.g., smartphones). In the case of online distribution, at least some of the computer program products (e.g., a downloadable application, etc.) may be at least temporarily stored in a storage medium readable by devices, such as memory of a manufacturer server, an application store server, or a relay server or temporarily generated.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic apparatus configured to determine an artificial intelligence (AI) service provider apparatus, the electronic apparatus comprising:
at least one processor comprising processing circuitry; and
memory comprising at least one storage medium storing at least one instruction,
wherein at least one processor, individually and/or collectively, is configured to execute the at least one instruction and to cause the electronic apparatus to:
obtain an utterance command of a user,
determine at least one of the electronic apparatus or an external electronic apparatus as the AI service provider apparatus, based on the utterance command of the user and source information of contents displayed on a screen of at least one of the electronic apparatus or the external electronic apparatus, and
control the electronic apparatus to perform an operation corresponding to the utterance command of the user through the determined AI service provider apparatus.

2. The electronic apparatus of claim 1, further comprising a communicator, comprising communication circuitry,
wherein at least one processor, individually and/or collectively configured to cause the electronic apparatus to:
identify source information of contents displayed on a screen of the external electronic apparatus,
transmit the utterance command of the user to the external electronic apparatus through the communicator based on a source of the contents of the external electronic apparatus being the external electronic apparatus, and
perform an operation corresponding to the utterance command of the user based on the source of the contents of the external electronic apparatus being the electronic apparatus.

3. The electronic apparatus of claim 2, wherein the source information of the contents of the external electronic apparatus is received from the external electronic apparatus and stored in the memory.

4. The electronic apparatus of claim 1, further comprising a communicator, comprising communication circuitry,
wherein at least one processor, individually and/or collectively, is configured to cause the electronic apparatus to:
identify source information of contents displayed on a screen of the electronic apparatus,
perform an operation corresponding to the utterance command of the user based on a source of the contents of the electronic apparatus being the electronic apparatus, and
transmit the utterance command of the user to the external electronic apparatus through the communicator based on the source of the contents of the electronic apparatus being the external electronic apparatus.

5. The electronic apparatus of claim 1, wherein at least one processor, individually and/or collectively, is configured to cause the electronic apparatus to:
analyze a user intent of the utterance command of the user from at least one token corresponding to the utterance command of the user based on the electronic apparatus being determined as the AI service provider apparatus and
perform an operation corresponding to the user intent.

6. The electronic apparatus of claim 1, wherein the AI service provider apparatus corresponding to the utterance command of the user is determined further based on at least one of device specification information of the electronic apparatus, capability information of the electronic apparatus, on-device AI-related information of the electronic apparatus, device specification information of the external electronic apparatus, capability information of the external electronic apparatus, or on-device AI-related information of the external electronic apparatus.

7. The electronic apparatus of claim 6, wherein the device specification information includes at least one of device type information, processor information, memory information, performance information of an AI-dedicated processor, AI service type information, information about device-based AI service support, occupancy information of an AI-dedicated processor, or performance information of an on-device AI model.

8. The electronic apparatus of claim 1, wherein at least one processor, individually and/or collectively, is configured to cause the electronic apparatus to determine to provide an AI service using at least one of a device-based method or a server-based method based on performance information of an AI-dedicated processor, occupancy information of an AI-dedicated processor, information about device-based AI service support, performance information of an on-device AI model, or network environment information of each of the electronic apparatus and the external electronic apparatus.

9. The electronic apparatus of claim 4, wherein at least one processor, individually and/or collectively, is configured to cause the electronic apparatus to:
determine to activate a microphone of at least one of the electronic apparatus or an external electronic apparatus, based on the source information of the contents displayed on the screen of at least one of the electronic apparatus or the external electronic apparatus,
determine to activate a microphone of the external electronic apparatus based on the source of the contents of the external electronic apparatus being the external electronic apparatus, and
determine to activate a microphone of the electronic apparatus based on the source of the contents of the external electronic apparatus being the electronic apparatus.

10. The electronic apparatus of claim 9, wherein at least one processor, individually and/or collectively, is configured to cause the electronic apparatus to determine to activate at least one of the microphone of the electronic apparatus or the microphone of the external electronic apparatus, based on at least one of positions of the electronic apparatus and the user, positions of the external electronic apparatus and the user, or whether a low power mode is on.

11. A method of operating an electronic apparatus configured to determine an artificial intelligence (AI) service provider apparatus, the method comprising:
obtaining an utterance command of a user;
determining at least one of the electronic apparatus or an external electronic apparatus as the AI service provider apparatus, based on the utterance command of the user and source information of contents displayed on a screen of at least one of the electronic apparatus or the external electronic apparatus; and
controlling the electronic apparatus to perform an operation corresponding to the utterance command of the user through the determined AI service provider apparatus.

12. The method of claim 11, further comprising:
identifying source information of contents displayed on a screen of the external electronic apparatus;
transmitting the utterance command of the user to the external electronic apparatus through a communicator comprising communication circuitry based on a source of the contents of the external electronic apparatus being the external electronic apparatus; and
performing an operation corresponding to the utterance command of the user based on the source of the contents of the external electronic apparatus being the electronic apparatus.

13. The method of claim 12, wherein the source information of the contents of the external electronic apparatus is received from the external electronic apparatus and stored in the memory.

14. The method of claim 11, further comprising:
identifying source information of contents displayed on a screen of the electronic apparatus;
performing an operation corresponding to the utterance command of the user based on a source of the contents of the electronic apparatus being the electronic apparatus; and
transmitting the utterance command of the user to the external electronic apparatus through the communicator based on the source of the contents of the electronic apparatus being the external electronic apparatus.

15. The method of claim 11, wherein the controlling of the electronic apparatus to perform the operation corresponding to the utterance command by the user comprises:
analyzing a user intent of the utterance command of the user from at least one token corresponding to the utterance command of the user based on the electronic apparatus being determined as the AI service provider apparatus; and
performing an operation corresponding to the user intent.

16. The method of claim 1, wherein an AI service provider apparatus corresponding to the utterance command of the user is determined further based on at least one of device specification information of the electronic apparatus, capability information of the electronic apparatus, information regarding on-device AI of the electronic apparatus, device specification information of the external electronic apparatus, capability information of the external electronic apparatus, or information regarding on-device AI of the external electronic apparatus.

17. The method of claim 16, wherein the device specification information includes at least one of device type information, processor information, memory information, performance information of an AI-dedicated processor, AI service type information, information about device-based AI service support, occupancy information of an AI-dedicated processor, or performance information of an on-device AI model.

18. The method of claim 11, further comprising determining to provide an AI service using at least one of a device-based method or a server-based method based on performance information of an AI-dedicated processor, occupancy information of an AI-dedicated processor, information about device-based AI service support, performance information of an on-device AI model, or network environment information of each of the electronic apparatus and the external electronic apparatus.

19. The method of claim 14, further comprising:
determining to activate a microphone of at least one of the electronic apparatus or the external electronic apparatus based on the source information of the contents displayed on the screen of at least one of the electronic apparatus or the external electronic apparatus;
determining to activate a microphone of the external electronic apparatus based on the source of the contents of the external electronic apparatus being the external electronic apparatus; and
determining to activate a microphone of the electronic apparatus based on the source of the contents of the external electronic apparatus being the electronic apparatus.

20. A non-transitory computer-readable recording medium having recorded thereon a program which, when executed by at least one processor of an electronic apparatus, causes the electronic apparatus to perform a method, wherein the method comprises:
obtaining an utterance command of a user;
determining at least one of the electronic apparatus or an external electronic apparatus as the AI service provider apparatus, based on the utterance command of the user and source information of contents displayed on a screen of at least one of the electronic apparatus or an external electronic apparatus; and
controlling the electronic apparatus to perform an operation corresponding to the utterance command of the user through the determined AI service provider apparatus.
